(19) United States
(12) Patent Application Publication
(10) Pub. No.: US 2026/0161714 A1
(43) Pub. Date: Jun. 11, 2026

(54) METHOD FOR OUTPUTTING DOCUMENT SEARCH RESULT AND DOCUMENT SEARCH SYSTEM

(71) Applicant: SEMICONDUCTOR ENERGY LABORATORY CO., LTD., Atsugi-shi, Kanagawa-ken (JP)

(72) Inventors: Yoshitaka DOZEN, Atsugi, Kanagawa (JP); Kunitaka YAMAMOTO, Atsugi, Kanagawa (JP)

(21) Appl. No.: 18/703,783

(22) PCT Filed: Oct. 18, 2022
(86) PCT No.: PCT/IB2022/059967

§ 371 Date: Apr. 23, 2024

(30) Foreign Application Priority Data
Oct. 28, 2021 (JP) 2021-176470

(51) Int. Cl. G06F 16/9038; G06F 16/93

(52) U.S. Cl. CPC G06F 16/9038; G06F 16/93

(57) ABSTRACT

A change in documents and search results based on a search query are checked efficiently. A method for outputting a document search result includes a step of specifying at least one document to be searched, a step of searching the at least one document using a search query including at least one keyword, a step of displaying a search result on a screen, and a step of displaying a sentence on the screen. The at least one document includes a plurality of versions. In the step of displaying a search result on a screen, a keyword shown up in each of versions of the document is displayed together with information specifying the version where the keyword is shown up. The sentence is included in the version of the document selected from the search result displayed on the screen.

### TECHNICAL FIELD

One embodiment of the present invention relates to a document search system. One embodiment of the present invention relates to a document search method. One embodiment of the present invention relates to a method for outputting a document search result. One embodiment of the present invention relates to a method for displaying a document search result.

Note that one embodiment of the present invention is not limited to the above technical field. Examples of the technical field of one embodiment of the present invention include a semiconductor device, a display device, a light-emitting device, a power storage device, a storage device, an electronic device, a lighting device, an input device (e.g., a touch sensor), an input/output device (e.g., a touch panel), a method for driving any of them, and a method for manufacturing any of them.

### BACKGROUND ART

Examples of tasks relating to patents include the prior art search, acquisition of patent right, and patent invalidity search. Prior art search before application for an invention can reveal if there is a relevant intellectual property right. Domestic or foreign patent documents, papers, and the like obtained through the prior art search are helpful in confirming the novelty and non-obviousness of the invention and determining whether to file the application. In addition, patent invalidity search can reveal whether there is a possibility of invalidation of the patent right owned by an applicant or whether the patent rights owned by others can be rendered invalid.

Since the tasks relating to patents are wide-ranging, support systems for the tasks related to patents, such as a support system for creating patent application documents, a patent-information analysis system, and a document search system, have been developed in recent years. Patent Document 1 discloses a support system for creating application documents that has a function of extracting claims including an input keyword and displaying the claims.

### REFERENCE

### Patent Document

[Patent Document 1] Japanese Published Patent Application No. 2012-48696

### SUMMARY OF THE INVENTION

### Problems to be Solved by the Invention

Documents such as patent application documents and contracts each have a plurality of versions in which a changing process or an editing process is reflected in some cases. It is important to clarify transition in the changing process or the editing process when a user evaluate or understand the document or further changes or edits the document. However, it is not easy to check the transition in the changing process or the editing process when a difference between before and after changing or editing the document is small.

An object of one embodiment of the present invention is to provide a document search system or a method for outputting a document search result, which enables a user to check the transition in the document efficiently. Another object of one embodiment of the present invention is to provide a document search system or a method for outputting a document search result, which enables an efficient search using search queries and an efficient check of a result of the search.

Another object of one embodiment of the present invention is to provide a document search system or a method for outputting a document search result, which can be operated easily by a user. Another object of one embodiment of the present invention is to provide a document search system or a method for outputting a document search result, which enables a user to obtain needed information efficiently.

Note that the description of these objects does not preclude the existence of other objects. One embodiment of the present invention does not need to achieve all of these objects. Other objects can be derived from the description of the specification, the drawings, and the claims.

### Means for Solving the Problems

One embodiment of the present invention is a method for outputting a document search result including a step of specifying at least one document that is to be searched, a step of searching at least one document using a search query including at least one keyword, a step of displaying a search result on a screen, and a step of displaying a sentence on the screen. At least one document includes a plurality of versions. In the step of displaying a search result on a screen, a keyword shown up in each of the versions of the document is displayed together with information specifying the versions including the keyword shown up. The sentence is included in any one of the versions of the document selected from the search result displayed on the screen.

In the step of displaying a sentence on the screen in the above method for displaying a document search result, the keyword included in the sentence is preferably emphasized.

In the method for displaying the document search result, the document is preferably “Scope of Claims” belonging to a patent application, and each of the plurality of versions preferably corresponds to an amendment in “Scope of Claims” in an examination process.

Another embodiment of the present invention is a method for outputting a document search result including a step of receiving an identifier, a step of receiving a search query, a step of obtaining a search result based on the search query from one or each of a plurality of blocks included in a plurality of documents related to the identifier, and a step of outputting the search result from each block as a first table, together with the identifier specifying the document including the block.

In the above method for outputting a document search result, it is preferable that the search query be output when each of the plurality of documents includes at least one block satisfying the search query, so that the search result is output into the first table.

Another embodiment of the present invention is a method for outputting a document search result including a step of receiving an identifier, a step of receiving a first search query and a second search query, a step of obtaining a first search result based on the first search query and a second search result based on the second search query from one or each of a plurality of blocks included in each of a plurality of documents related to the identifier, and a step of outputting the first search result and the second search result from each of the blocks as a first table, together with the identifier specifying the document including the block.

In the above method for outputting a document search result, it is preferable that the first search query be output when each of the plurality of documents includes at least one block satisfying the first query, so that the first search result is output into the first table, and it is preferable that the second search query be output when each of the plurality of documents includes at least one block satisfying the second search query, so that the second search result is output into the first table.

The above method for outputting a document search result preferably further includes a step of outputting a sentence. In the step of outputting the search result as the first table, the first table is preferably displayed on a screen. The sentence is preferably included in a document selected from the first table displayed on the screen. In the step of outputting a sentence, the sentence is preferably displayed on the screen.

In the above method for outputting a document search result, a keyword included in the search query is preferably emphasized in the sentence displayed on the screen.

In the above method for outputting a document search result, each of the plurality of documents is preferably “Scope of Claims”, the identifier is preferably a patent application management number or a patent application family management number, and the block is preferably a claim.

Another embodiment of the present invention is a document search system including a storage unit, a reception unit, a processing unit, and an output unit. The storage unit includes a database. The reception unit has a function of receiving a search query and an identifier. The processing unit has a function of extracting a plurality of documents related to the identifier from the database and a function of obtaining a search result based on the search query from one or each of a plurality of blocks included in each of the plurality of documents extracted from the database. The output unit has a function of outputting the search result obtained from the block as a first table, together with the identifier specifying the document including the block.

In the above document search system, it is preferable that the search query be output when each of the plurality of documents includes at least one block satisfying the search query, so that the search result is output into the first table.

Another embodiment of the present invention is a document search system including a storage unit, a reception unit, a processing unit, and an output unit. The storage unit includes a database. The reception unit has a function of receiving a first search query, a second search query, and an identifier. The processing unit has a function of extracting a plurality of documents related to the identifier and a function of obtaining a first search result and a second search result based on the first search query and the second search query, respectively, from one or each of a plurality of blocks included in each of the plurality of documents extracted from the database. The output unit has a function of outputting the first query result and the second query result obtained from the block as a first table, together with the identifier specifying a sentence including the block.

In the above document search system, it is preferable that the first search query be output when each of the plurality of documents includes at least one block satisfying the first search query, so that the first search result is output into the first table, and it is preferable that the second query be output when each of the plurality of documents includes at least one block satisfying the second search query, so that the second search result is output to the first table.

In the above document search system, the database is preferably a patent application database, each of the plurality of documents is preferably “Scope of Claims”, the identifier is preferably a patent application management number or a patent application family management number, and the block is preferably a claim.

### Effect of the Invention

With one embodiment of the present invention, a document search system or a method for outputting a document search result, which enables a user to check the transition in the document efficiently, can be provided. With one embodiment of the present invention, a document search system or a method for outputting a document search result, which enables an efficient search using search queries and an efficient check of a result of the search, can be provided.

With one embodiment of the present invention, a document search system or a method for outputting a document search result, which can be operated easily by a user, can be provided. With one embodiment of the present invention, a document search system or a method for outputting a document search result, which enables a user to obtain needed information efficiently, can be provided.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

FIG. 1 is a diagram illustrating an example of a document search system.

FIG. 2 is a diagram illustrating an example of a document search method.

FIG. 3A and FIG. 3B each illustrate an example of a graphical user interface.

FIG. 4 illustrates an example of a graphical user interface.

FIG. 5 illustrates an example of a graphical user interface.

FIG. 6 illustrates an example of a graphical user interface.

FIG. 7A to FIG. 7D each illustrate an example of a graphical user interface.

FIG. 8 illustrates an example of a graphical user interface.

FIG. 9A to FIG. 9E each illustrate an example of a graphical user interface.

FIG. 10A to FIG. 10D each illustrate an example of a graphical user interface.

FIG. 11 illustrates an example of a graphical user interface.

FIG. 12 illustrates an example of a graphical user interface.

FIG. 13 is a diagram illustrating an example of a document search system.

FIG. 14 is a diagram illustrating an example of a document search system.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments.

Note that in structures of the invention described below, the same portions or portions having similar functions are denoted by the same reference numerals in different drawings, and the description thereof is not repeated. The same hatching pattern is used for portions having similar functions, and the portions are not especially denoted by reference numerals in some cases.

Note that ordinal numbers such as “first”, “second”, and “third” used in this specification and the like are used in order to avoid confusion among components, and the terms do not limit the components numerically. For example, the first row is not limited to the first row and the first column is not limited to the first column.

The position, size, range, or the like of each component illustrated in drawings does not represent the actual position, size, range, or the like in some cases for easy understanding. Therefore, the disclosed invention is not necessarily limited to the position, size, range, or the like disclosed in the drawings.

In this specification and the like, when a plurality of components are denoted with the same reference numerals, and in particular need to be distinguished from each other, an identification sign such as “_1”, “[n]”, or “[m,n]” is sometimes added to the reference numerals.

In this specification and the like, a document means a description of a phenomenon in natural language, which includes one or more sentences and is computerized and machine-readable, unless otherwise described. Examples of a document include patent applications, legal precedents, contracts, terms and conditions, regulations, product manuals, novels, publications, white papers, and technical documents, but are not limited thereto. Note that the document may include a plurality of versions in which a changing process or an editing process is reflected. In this case, a serial number for identifying a version, a date, or the like is assigned to each version of the document in some cases. Here, in the case where a document corresponds to “Scope of Claims” of a patent application document, the changing or editing means an amendment or correction in “Scope of Claims”. Furthermore, in the case where an amendment is made two times during an examination process, it can be said that the subject document has three versions including a version at the time of patent application.

In this specification and the like, an identifier refers to an identification sign for identifying a specific document from a plurality of documents. The identifier is assigned per item such as a title and a publisher. The identification sign is composed of a combination of letters, numbers, symbols, and the like. When a specific document is identified from a plurality of documents, one identifier may be used or a plurality of identifiers may be combined.

In this specification and the like, a search query is a concept a user wants to search for, which is expressed in some form. Here, the search query refers to various search conditions to be input by a user making a search. There is no particular limitation on the search conditions, and examples of the search conditions include one or more words, one or more phrases, and one or more sentences. Alternatively, examples of the search conditions include a search formula constructed by a logical operator and at least one kind of one or more words, one or more phrases, and one or more sentences. The logical operator is also referred to as a Boolean operator, and examples include, but not limited to, AND, OR, and NOT. When these logical operators are used, the search formula is an AND search, an OR search, an NOT search, or the like. Alternatively, a natural sentence may be received as the search query, and a word extracted by language processing may be used as a search keyword or a sentence vector may be generated using distributed representation.

In this specification and the like, the collection of data is configured with a model of columns and rows (vertical axis and horizontal axis) is referred to a table or a table format. Thus, the collection of data can be referred to as a table or a table format when it is configured with a model of columns and rows (vertical axis and horizontal axis) regardless of the presence or absence of ruled lines.

### EMBODIMENT 1

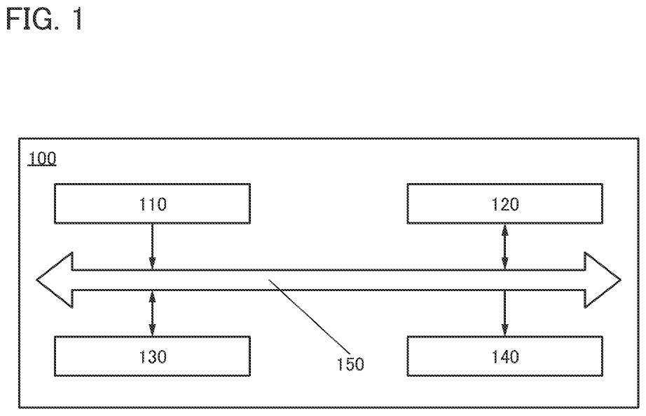

In this embodiment, a document search system, a document search method, a method for outputting a document search result, and a method for displaying a document search result, which are embodiments of the present invention, will be described with reference to FIG. 1 to FIG. 12.

In the document search system of one embodiment of the present invention, a search result based on a received search query is obtained from each of a plurality of documents. In addition, the search result in each of the plurality of documents is output into a table format. Note that the number of documents from which the search result is obtained may be one. The output of the search result is not limited to the table format, and it is preferable that the search result be output with information specifying a document. The search result may be output in a tree format (tree structure), for example.

For example, output can be performed by one or both of displaying search results on a display screen (simply described as “screen” in this specification and the like) of a user's terminal and outputting a file in a CSV format or the like. Note that there is no particularly limitation on the display screen as long as it belongs to display devices, and may be a multidisplay described later, for example.

For example, one of a group of items on the vertical axis and a group of items on the horizontal axis of the table represents documents, and the other represents search queries.

As a specific example, when a search query is received, a search result based on the search query can be shown in the first column of the table. In addition, when objects from which a search result is obtained are a first document and a second document, a search result from the first document can be shown in the first row of the table and a search result from the second document can be shown in the second row of the table.

Furthermore, in the document search system of one embodiment of the present invention, a document is selected from the table showing a search result displayed on a display screen, which allows the document to be displayed on the same display screen.

The number of search queries to be received may be one or two or more. For example, in the case where two queries (a first search query and a second search query) are received, a first search result based on the first search query and a second search result based on the second search query can be shown in the first column of the table. Such output can enhance browsability of search results based on a plurality of search queries. Note that the first search result based on the first search query may be shown in the first column of the table, and the second search result based on the second search query may be shown in the second column of the table.

### <Document Search System 1>

FIG. 1 shows a block diagram of a document search system 100. The document search system 100 includes a reception unit 110, a storage unit 120, a processing unit 130, an output unit 140, and a transmission path 150.

The document search system 100 may be provided in a data processing device such as a personal computer used by a user. Alternatively, a processing unit of the document search system 100 may be provided in a server to be accessed by a client PC via a network and used.

### [Reception Unit 110]

The reception unit 110 receives a search query. The number of search queries received by the reception unit 110 may be one or two or more. For example, in the case where the number of search queries is two, the reception unit 110 receives a first search query and a second search query.

In this embodiment, a search query received by the reception unit 110 is described as one or more words, one or more phrases, one or more sentences, or a combination thereof. For example, in the case where the reception unit 110 receives a plurality of search queries, each of the plurality of search queries is one word, one phrase, or one sentence. Hereinafter, a word, a phrase, or a sentence which the user inputs as a search query is referred to as a keyword in some cases.

The reception unit 110 receives designation of a document group (a plurality of documents) to be searched. For example, the reception unit 110 receives at least one of identifiers assigned per item of the documents. Here, the document group to be searched is composed of a plurality of documents. Thus, “document group” in this specification and the like can be rephrased as “a plurality of documents”. Note that a document to be searched may be one.

The reception unit 110 may receive data relating to a document. For example, the reception unit 110 may receive text data or the like of a document to be searched.

The reception unit 110 has a function of transmitting and receiving data. At this time, the reception unit 110 can be rephrased as a communication unit. Examples of the communication unit include a hub, a router, and a modem. The reception unit 110 may have a function of receiving a user's input operation. In this case, the reception unit 110 can be rephrased as an input unit. Examples of the input unit include a mouse, a keyboard, a touch panel, a microphone, a scanner, and a camera.

The search query and identifier supplied to the reception unit 110 is supplied to one or both of the storage unit 120 and the processing unit 130 through the transmission path 150.

### [Storage Unit 120]

The storage unit 120 has a function of storing a program executed by the processing unit 130. The storage unit 120 preferably has a function of storing search results obtained by the processing unit 130 and data in a table format generated by the processing unit 130. The storage unit 120 may have a function of storing a calculation result and an inference result generated by the processing unit 130, data input to the reception unit 110, and the like.

The storage unit 120 includes at least one of a volatile memory and a nonvolatile memory. As the volatile memory, a DRAM (Dynamic Random Access Memory), an SRAM (Static Random Access Memory), and the like can be given. Examples of the nonvolatile memory include an ReRAM (Resistive Random Access Memory, also referred to as a resistance-change memory), a PRAM (Phase change Random Access Memory), an FeRAM (Ferroelectric Random Access Memory), an MRAM (Magnetoresistive Random Access Memory, also referred to as a magneto-resistive memory), and a flash memory. The storage unit 120 may include a storage media drive. As the storage media drive, a hard disk drive (HDD), a solid state drive (SSD), or the like can be given.

The storage unit 120 may include a database containing document data.

The document search system 100 may have a function of extracting (reading) document data (specifically, data needed for subsequent processing) from a database existing outside the system.

Alternatively, the document search system 100 may have a function of extracting data from both of its own database and an external database.

The database can have a structure containing either or both of text data and image data, for example.

One or both of a storage and a file server may be used instead of the database. For example, in the case where a file contained in a file server is used, the database preferably contains a path for the file stored in the file server.

An application database can be given as an example of the database. Examples of the application include applications relating to intellectual properties, such as a patent application, an application for utility model registration, and an application for design registration. There is no limitation on each status of the applications, i.e., whether or not it is published, whether or not it is pending in the Patent Office, and whether or not it is registered. For example, the application database can contain at least one of applications before examination, applications under examination, and registered applications, or may contain all of them.

For example, the application database preferably contains one or both of a specification and “Scope of Claims” for each of a plurality of patent applications. Note that as “Scope of Claims”, a plurality of claims belonging to one version of one application are collectively treated as one document. The application database preferably contains documents stored as progress records or examination records of the application. For example, the application database preferably contains amendments of proceedings, written reports, and the like of a plurality of patent applications. The application database may further contain abstracts of a plurality of patent applications. The specification, “Scope of Claims”, amendment of proceedings, written report, and abstract are stored in text data, for example.

The application database may contain at least one of an application management number for identifying the application (including a number for internal use, a given number designated by a user, or the like), an application family management number for identifying the application family, an application number, a publication number, a registration number, a drawing, an application date, a priority date, a publication date, a status, a classification (e.g., patent classification or utility model classification), a category, a keyword, and the like. The application database may contain information on progress records or examination records of the application. For example, the application database may contain at least one of a history management number (including a number for internal use, a given number designated by a user, or the like), a filling date, a receiving date, and the like. These pieces of information can each be used to specify a document group when designation of a document group to be searched is received. Thus, these pieces of information can be used as items for identifying a document. Alternatively, these pieces of information may each be output together with a document search result. In each of the documents contained in the application database, an identifier is assigned per item identifying the document.

In addition, a variety of kinds of documents such as legal precedents, contracts, terms and conditions, regulations, and product manuals can be managed with the database. The database contains at least text data of documents. The database may contain at least one of an identification number of each document, the title, the date of issue or the like, the author name, the publisher name, and the like. These pieces of information can each be used to specify a document group when designation of a document group to be searched is received. Thus, these pieces of information can be used as items for identifying a document. Alternatively, these pieces of information may each be output together with a document search result.

Note that a document can be divided into a plurality of blocks in accordance with various rules. Note that “block” described in this specification and the like refers to a batch of sentences and includes one or more sentences. The document can be divided into a plurality of blocks by paragraphs, sections, chapters, headings, clauses, pages, and the like, for example. For example, in the case where the document is divided by paragraphs, a block can be rephrased as a paragraph.

The database may contain at least one of numbers given to paragraphs (paragraph numbers), tittles or numbers of chapters, titles or numbers of headings, titles or numbers of clauses, page numbers, numbers given to sentences (sentence numbers), and the like. These pieces of information can each be used as an item for identifying a block.

Note that usage application of the document search system in this embodiment is not particularly limited, and the usage application examples can include a survey of transition of documents such as “Scope of Claims”, contracts, and the like.

The storage unit 120 may include a thesaurus. When a thesaurus is included, for example, the processing unit 130 can add a synonym of a word or a phrase included in a search query received by the reception unit 110. Note that the processing unit 130 may be used for creation of a thesaurus. Furthermore, AI (artificial intelligence) may be used for the processing unit 130 to create the thesaurus.

### [Processing Unit 130]

The processing unit 130 has a function of performing processing such as arithmetic operation and inference with use of data supplied from one or both of the reception unit 110 and the storage unit 120. The processing unit 130 has a function of performing processing with use of various data contained in the database. The processing unit 130 can supply a processing result such as an arithmetic operation result or an inference result to one or both of the storage unit 120 and the output unit 140.

The processing unit 130 has a function of specifying a document group that is to be searched. For example, the processing unit 130 has a function of extracting a plurality of documents related to identifiers received by the reception unit 110 from the above database. In other words, the processing unit 130 has a function of receiving document data of the plurality of documents from the above database. In addition, the processing unit 130 has a function of obtaining a search result based on a search query received by the reception unit 110 from one or each of a plurality of blocks included in each of the plurality of documents extracted from the database. For example, when the reception unit 110 received two search queries (a first search query and a second search query), the processing unit 130 has a function of obtaining a first search result and a second search result based on the first search query and the second search query respectively, from one or each of a plurality of blocks included in each of the plurality of documents extracted from the database.

The processing unit 130 has a text search function. In particular, the processing unit 130 preferably has a text search function using a search formula generated by a combination of a word or a phrase and a logical operator.

The processing unit 130 has a function of generating data in a table format on the basis of a text search result. The data generated by the processing unit 130 is not limited to the table format and may be a tree format (tree structure), for example.

The processing unit 130 may have a function of obtaining, using a thesaurus, a synonym of a word or a phrase included in a search query received by the reception unit 110. In addition, the processing unit 130 may perform text search after the search query is updated using the synonym. Thus, the search accuracy can be increased. Note that the synonym may include not only a related word in the same language as the word or phrase included in the received search query but also a translation of the word and phrase included in the received search query into another language and a related word thereof. For example, as a synonym of an English term “light shielding”, an English term “light blocking”, a Japanese term meaning “light shielding”, and the like can be included.

The processing unit 130 can include an arithmetic circuit, for example. The processing unit 130 can include, for example, a central processing unit (CPU).

The processing unit 130 may include a microprocessor such as a DSP (Digital Signal Processor) or a GPU (Graphics Processing Unit). The microprocessor may be constructed with a PLD (Programmable Logic Device) such as an FPGA (Field Programmable Gate Array) or an FPAA (Field Programmable Analog Array). The processing unit 130 can interpret and execute instructions from programs with use of a processor to process various kinds of data and control programs. The programs to be executed by the processor are stored in at least one of a memory region of the processor or the storage unit 120.

The processing unit 130 may include a main memory. The main memory includes at least one of a volatile memory such as a RAM (Random Access Memory) and a nonvolatile memory such as a ROM (Read Only Memory).

For example, a DRAM, an SRAM, or the like is used as the RAM, a virtual memory space is assigned in the RAM and utilized as a working space of the processing unit 130. An operating system, an application program, a program module, program data, a look-up table, and the like that are stored in the storage unit 120 are loaded into the RAM for execution. The data, program, and program module that are loaded into the RAM are each directly accessed and operated by the processing unit 130.

In the ROM, a BIOS (Basic Input/Output System), firmware, and the like for which rewriting is not needed can be stored. Examples of the ROM include a mask ROM, an OTPROM (One Time Programmable Read Only Memory), and an EPROM (Erasable Programmable Read Only Memory). Examples of the EPROM include a UV-EPROM (Ultra-Violet Erasable Programmable Read Only Memory) which can erase stored data by ultraviolet irradiation, an EEPROM (Electrically Erasable Programmable Read Only Memory), and a flash memory.

The document search system of one embodiment of the present invention may use AI for part of processing. The document search system may use an artificial neural network (ANN; hereinafter just referred to as neural network). The neural network is obtained with a circuit (hardware) or a program (software).

In this specification and the like, a neural network refers to a general model that is modeled on a biological neural network, determines the connection strength of neurons by learning, and has the capability of solving problems. A neural network includes an input layer, intermediate layers (hidden layers), and an output layer.

In the description of the neural network in this specification and the like, to determine a connection strength of neurons (also referred to as a weight coefficient) from the existing information is referred to as “learning” in some cases.

In this specification and the like, to draw a new conclusion from a neural network formed with the connection strength obtained by learning is referred to as “inference” in some cases.

For example, processing with AI can be employed for the above function of creating the thesaurus.

### [Output Unit 140]

The output unit 140 outputs information based on a processing result of the processing unit 130. For example, the output unit 140 can supply one or both of the arithmetic operation result and the inference result of the processing unit 130 to the outside of the document search system 100. Furthermore, the output unit 140 can output various kinds of data contained in a database on the basis of a processing result of the processing unit 130. The output unit 140 can output information to a display device (display), a speaker, or the like used by the user.

The output unit 140 has a function of outputting a search result obtained from a block into a table format, together with an identifier specifying a document including the block. For example, when the reception unit 110 receives two search queries (a first search query and a second search query), the output unit 140 outputs a first search result and a second search result obtained from the block into a table format, together with an identifier specifying a document including the block. Note that the research result output by the output unit 140 is not limited to the table format and may be a tree format (tree structure), for example.

The output unit 140 preferably has a function of transmitting and receiving data. At this time, the output unit 140 can be referred to as a communication unit. Examples of the communication unit include a hub, a router, and a modem. The output unit 140 may have a function of displaying a processing result. At this time, the output unit 140 can be referred to as a display unit. Examples of the display unit includes display devices such as a liquid crystal display device and a light-emitting display device. The number of display devices used as the display unit is not limited. The number of display devices used as the display unit may be one or two or more. A display unit where a plurality of display devices are arranged is referred to as a multimonitor or multidisplay in some cases.

### [Transmission Path 150]

The transmission path 150 has a function of transmitting data. Data transmission and reception among the reception unit 110, the storage unit 120, the processing unit 130, and the output unit 140 can be performed through the transmission path 150.

Although the functions included in the document search system 100 are classified and independent from each other in FIG. 1, part or all of the functions included in the document search system 100 are not necessarily independent. For example, the processing unit 130 may have one or both of functions of the reception unit 110 and the output unit 140. In other words, the processing unit 130 may serve as one or both of the reception unit 110 and the output unit 140.

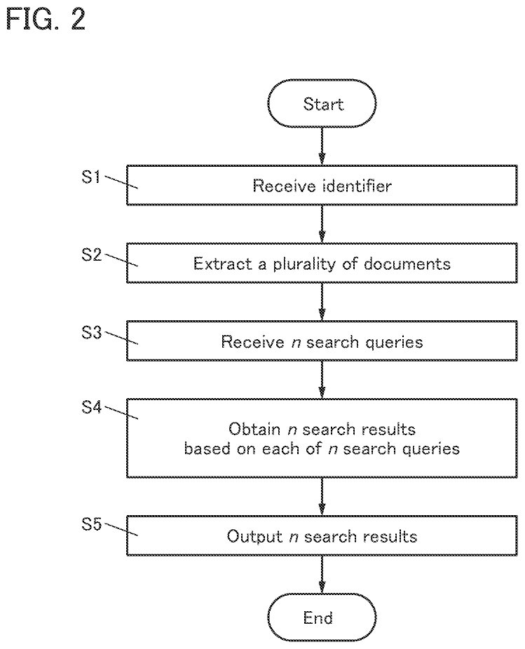

A document search method and a method for outputting a document search result of the document search system of one embodiment of the present invention are described with reference to FIG. 2 to FIG. 12. Note that a display method using a display is given below as an example of the output method. That is, the method for displaying a document search result of one embodiment of the present invention is described below.

### <Method for Displaying Document Search Result>

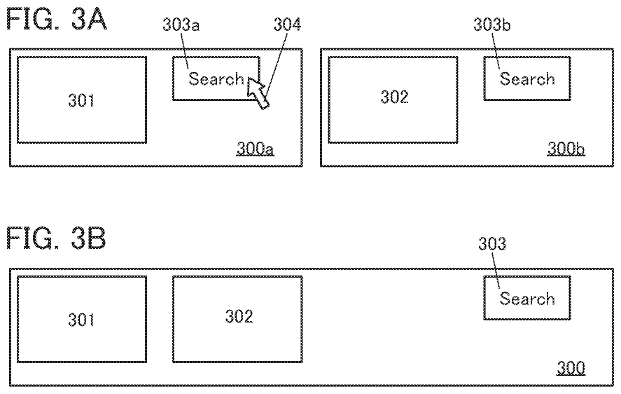

The method for displaying a document search result of this embodiment includes processing of Step S1 to Step S5 shown in FIG. 2. FIG. 3 to FIG. 12 each illustrate an example of a graphical user interface (GUI) of the document search system of this embodiment. Icons, windows, buttons, text boxes, and the like and the placement thereof in FIG. 3 to FIG. 12 are examples and there are no particularly limitations thereon. A GUI can be constructed as a web page accessed by a user via a network. Alternatively, a GUI can be constructed as a screen of a program application executed on an information processing device such as a personal computer used by the user.

### [Step S1]

In Step S1, an identifier is received. The user inputs an identifier, thereby being capable of designating a document group (a plurality of documents) to be searched among documents contained in a database and the like. Hereinafter, an identifier received in Step S1 is referred to as a first identifier in some cases. An item to which the first identifier is assigned is referred to as a first item in some cases.

In the case where the database is an application database, the first identifier (the first item) is an application management number or an application family management number, for example. Alternatively, for example, the first identifier may be one selected from an application number, a publication number, a registered number, and the like. Furthermore, when the database handles the management of documents such as legal precedents, contracts, terms and conditions, regulations, and product manuals, the first identifier (the first item) may be one selected from a number for identifying a document, a title, a date such as a date of issue, and the like.

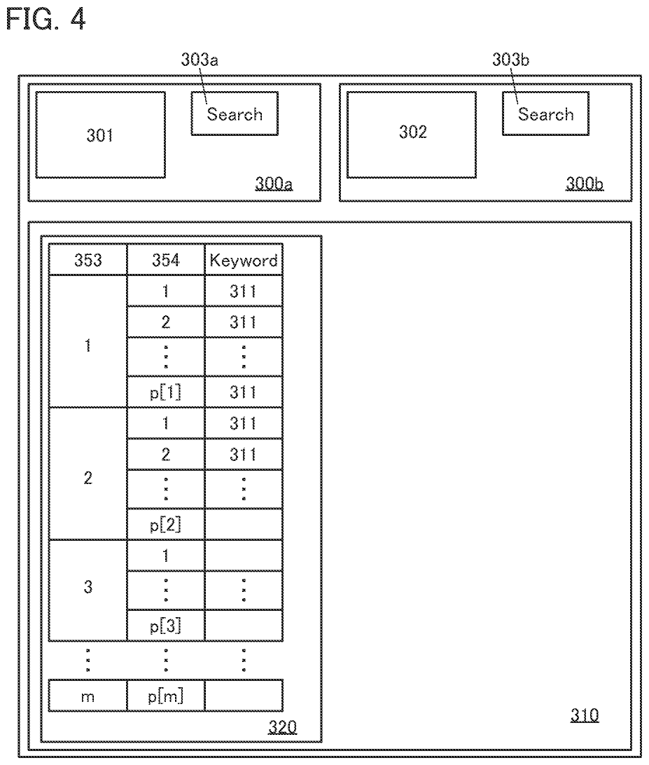

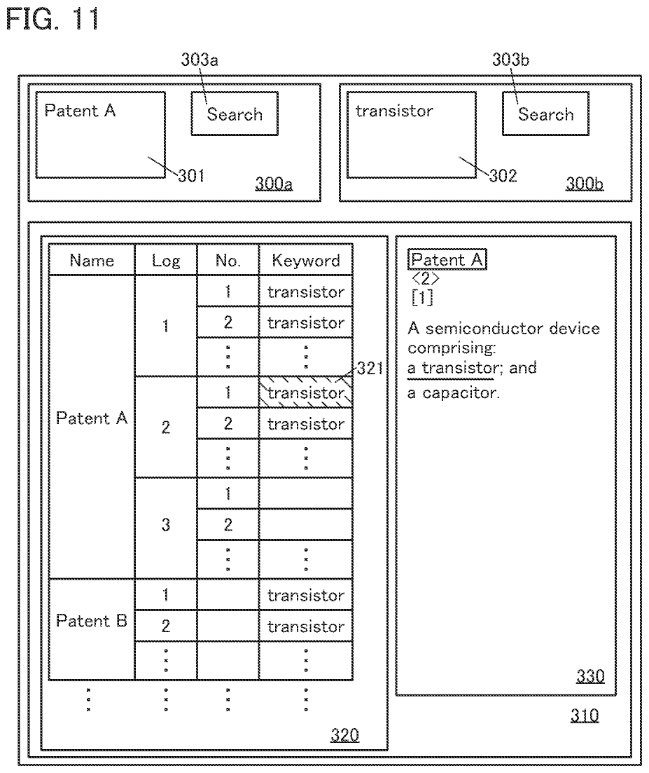

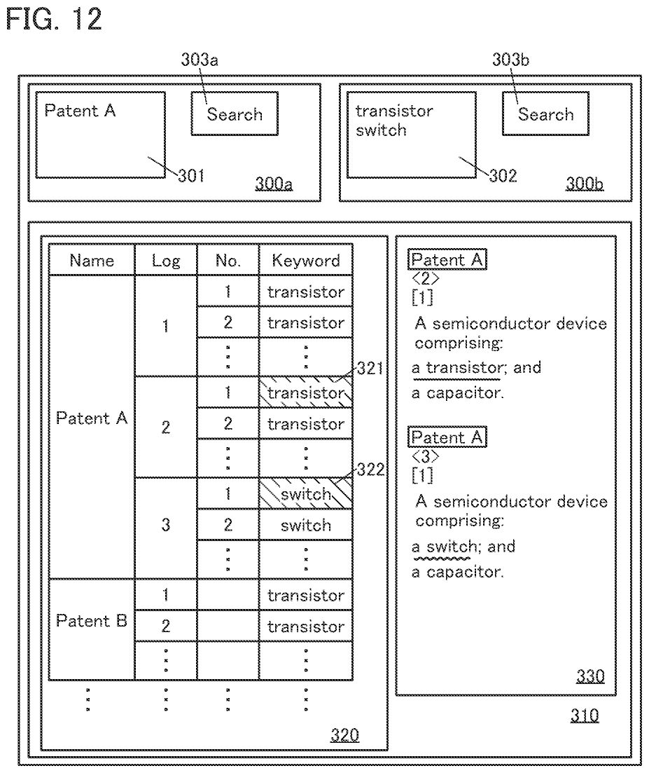

A region 300a illustrated in FIG. 3A, FIG. 4 to FIG. 6, FIG. 11, and FIG. 12 is a region that can be used for inputting an identifier by the user. In FIG. 3A, FIG. 4 to FIG. 6, FIG. 11, and FIG. 12, a region 301 where an identifier is input is displayed in the region 300a.

As illustrated in FIG. 3A, after inputting the first identifier to the region 301, the user selects an icon 303a denoted as “Search” with a mouse pointer 304, whereby the document search system receives the first identifier and starts to specify a document group (a plurality of documents) on the basis of the first identifier.

### [Step S2]

In Step S2, a document group (a plurality of documents) related to the first identifier is extracted. For example, the document search system extracts (reads) data on the document group (the plurality of documents) related to the first identifier input by the user (specifically, data necessary for the subsequent processing) from the database. For example, data on the document group (the plurality of documents) related to the first identifier input by the user is supplied from the database to the processing unit. Furthermore, for example, the processing unit receives data on the document group (the plurality of documents) related to the first identifier input by the user from the database.

The document group extracted from the database (supplied from the database to the processing unit) in Step S2 is composed of a plurality of documents to which the first identifier is assigned as the first item. At this time, the first identifier is common to the plurality of documents. Note that the document group extracted in Step S2 may be composed of a first document to which the first identifier is assigned and a plurality of second documents to which a second identifier the same as that in the first document is assigned; details thereof is described later.

For example, when the database is an application database and the first identifier (the first item) is an application management number, the document group related to the above first identifier is composed of a plurality of “Scope of Claims” whose application management numbers are the same. In this case, the document group related to the first identifier corresponds to “Scope of Claims” belonging to the patent application. Each of the plurality of documents related to the first identifier can correspond to “Scope of Claims”.

As the plurality of “Scope of Claims” whose application management numbers are the same, a plurality of versions of “Scope of Claims” can be given. For example, when amendment or correction is made on “Scope of Claims” in one application related to the first identifier, the document group related to the first identifier includes a version of “Scope of Claims” at the time of application and a version of “Scope of Claims” after the amendment or correction. The version number after the amendment or correction, which can exist, is the same as the number of making amendments or corrections on “Scope of Claims”. In other words, a plurality of versions are compatible with a prosecution history or a file wrapper including amendments or corrections on “Scope of Claims”.

In this specification and the like, the prosecution history indicates a course from a patent application to a final treatment (such as a decision of refusal or a decision of a patent grant). Note that the final treatment may be replaced with another treatment in accordance with the status of application (pre-or post-examination, registered, or the like). For example, in a situation where the application has not been examined, the prosecution history indicates a course from the time of patent application to the time before request for examination. The file wrapper indicates documents exchanged between a patent applicant and a commissioner of the patent office or an examiner during the prosecution history.

From the above, it can be said that the plurality of “Scope of Claims” whose application management numbers are the same have different versions. The version can be identified by a history management number, a data, or the like. The history management number assigned to the version is regarded as a third identifier, whereby the plurality of “Scope of Claims” can be specified with a combination of the first identifier and the third identifier. In other words, the number of the plurality of “Scope of Claims” is equal to the number of combinations of the first identifier and the third identifier. Hereinafter, an item to which the third identifier is assigned is referred to as a third item in some cases. When the number of third items are two or more, at least one of documents to be searched have a plurality of versions. In this case, it can be said that the plurality of versions correspond to respective amendments of “Scope of Claims” during an examination process.

Note that in the case where an amendment or correction is not made on “Scope of Claims” in one application, one document related to the first identifier include only a version of “Scope of Claims” at the time of application. In other words, the document group related to the first identifier is composed of one “Scope of Claims” having the same application management number.

Alternatively, in the case where the database is an application database and the first identifier (the first item) is an application family management number, for example, the document group related to the first identifier is composed of a plurality of “Scope of Claims” whose application family management numbers are the same. In this case, the document group related to the first identifier corresponds to “Scope of Claims” belonging to a patent application. It can be said that each of a plurality of documents related to the first identifier corresponds to “Scope of Claims”.

A plurality of applications whose application family management numbers are the same each has a plurality of versions of “Scope of Claims”, in some cases. Note that in the case where an amendment or correction is not made on “Scope of Claims” in one application, one document related to the first identifier include only a version of “Scope of Claims” at the time of application. In other words, it can be said that each of the plurality of applications whose application family management numbers are the same includes one or a plurality of “Scope of Claims”.

The document group extracted in Step S2 is not limited to the above. For example, the document group extracted in Step S2 may be composed of a first document to which the first identifier is assigned and a plurality of second documents to which a second identifier the same as the first document is assigned. Note that the number of second documents may be one. For example, the document search system specifies the first document to which the first identifier is assigned and the second document to which the second identifier the same as the first document is assigned. Here, an item to which the second identifier is assigned (referred to as a second item) is different from the first item.

In the case where the database is an application database, the first identifier (the first item) is an application management number, and the second identifier (the second item) is an application family management number, a document group extracted in Step S2 is composed of a plurality of “Scope of Claims” whose application family management numbers are the same, for example.

A plurality of applications whose application family management numbers are the same each has a plurality of versions of “Scope of Claims”, in some cases. It can be said that the plurality of versions of “Scope of Claims” included in the plurality of applications whose application family management numbers are the same are different. Thus, when a history management number assigned to a version is regarded as a third identifier, the plurality of “Scope of Claims” can be specified with a combination of the first identifier, the second identifier, and the third identifier. In other words, the number of the plurality of “Scope of Claims” is equal to the number of combinations of the first identifier, the second identifier, and the third identifier.

Also in the case where the database handles the management of documents such as legal precedents, contracts, terms and conditions, regulations, and product manuals, the third identifier (the third item) is a history management number, for example.

The document group extracted in Step S2 is to be searched. In this embodiment, the number of documents extracted in Step S2 (document subjected to search) is m (m is an integer greater than or equal to 1). At this time, the document group to be searched is composed of first to m documents. In particular, when a document group related to the first identifier is composed of a plurality of “Scope of Claims” whose application management numbers are the same, m corresponds to the number of versions of “Scope of Claims”.

As described above, the document can be divided into a plurality of blocks in accordance with various rules. That is, each of m documents includes one or a plurality of blocks. Thus, the minimum unit of a search target is a document or a block. Hereinafter, an item for identifying a block is referred to as a fourth item, and an identifier assigned to the fourth item is referred to as a fourth identifier. Note that i (i is an integer greater than or equal to 1 and less than or equal to m) documents include p[i] (p[i] is an integer greater than or equal to 1) blocks.

In the case where the database is an application database and the document group to be searched is composed of “Scope of Claims” in at least one of a plurality of versions and a plurality of applications, for example, one block corresponds to one claim, and the fourth identifier (the fourth item) is a claim number. In the case where the database handles the management of contracts, for example, one block preferably corresponds to one clause, and the fourth identifier (the fourth item) preferably corresponds to a clause number.

Note that Step S1 and Step S2 can be referred to, collectively, as a step of specifying a document group to be searched. In other words, Step S01 and Step S02 can be referred to, collectively, as a step for specifying at least one document to be searched. When the number of the third items are two or more, at least one document to be searched includes a plurality of versions. A method for specifying a document group to be searched in not limited thereto.

### [Step S3]

In Step S3, n (n is an integer greater than or equal to 1) search queries are received. In other words, at least one search query is received in Step S3. For example, in the case where the number of received search queries is one, Step S3 is a step of receiving one search query. For example, in the case where the number of received search queries is two, Step S3 is a step of receiving the first search query and the second search query.

There is no particular limitation on the search queries received in Step S3. For example, one word, one phrase, or one sentence can be received as one search query. For example, a search formula generated by a combination of one or more words and a logical operator may be received as one search query. The search query includes at least one keyword.

A region 300b illustrated in FIG. 3A, FIG. 4 to FIG. 6, FIG. 11, and FIG. 12 is a region that can be used for inputting a search query by the user. In FIG. 3A, FIG. 4 to FIG. 6, FIG. 11, and FIG. 12, a region 302 where a search query is input is displayed in the region 300b. When a plurality of search queries are input to the region 302, a delimiter is preferably provided between the search queries. Examples of the delimiters includes line breaks, tabs, semicolons, slashes, and back slashes. Alternatively, a word, a phrase, or a sentence included in a region sandwiched between single quotes, double quotes, or parentheses can be regarded as one search query.

Although FIG. 3A illustrates an example in which the region 300b includes one region where the search query is received, the present invention is not limited thereto. The region 300b may include a plurality of regions for receiving search queries. Thus, a plurality of search queries can be received without providing a delimiter and a plurality of searches can be executed.

After inputting the search query to the region 302, the user selects an icon 303b denoted as “Search” with a mouse pointer, whereby the document search system receives the search query and starts a search based on the search query.

In the case where the document search system obtains a synonym from a thesaurus or the like using a keyword included in the received search queries, the synonym may be automatically added to the search queries. Alternatively, the synonym may be displayed and the user may be requested to review the search queries. For example, the user can perform at least one of addition, change, and deletion of a keyword with reference to the synonym.

Note that although FIG. 3A illustrates a structure in which a region that can be used for inputting an identifier by the user and a region that can be used for inputting a search query by the user are provided in different regions, a structure of the GUI of the document search system is not limited thereto. For example, the regions that can be used for inputting an identifier and a search query by the user may be provided in one region.

For example, as illustrated in FIG. 3B, a region 301 where the first identifier is input and a region 302 where a search query is input may be provided in a region 300. In addition, an icon 303 illustrated in FIG. 3B may serve as an icon for starting a search for a document group based on the first identifier and an icon for starting a search based on the search query.

Specifically, in the case where the user selects the icon 303 with a mouse pointer in a state where the first identifier is input to the region 301 and the search query is not input to the region 302, the document search system preferably receives the first identifier and starts specifying a document group based on the first identifier.

Alternatively, in the case where the user selects the icon 303 with a mouse pointer in a state where the first identifier is input to the region 301 and the search query is input to the region 302, the document search system preferably receives the first identifier and the search query, starts specifying a document group based on the first identifier, and extracts the document group, followed by starting a search based on the search query. In this case, Step S1 also serves as Step S3. Therefore, in the processing illustrated in FIG. 2, the identifier and the search query are received in Step S1, and Step S3 can be omitted, in some cases.

### [Step S4]

In Step S4, n search results are obtained on the basis of each of the n search queries. In other words, in Step S4, at least one document specified in Step S2 is searched using the search query including at least one keyword, whereby the search result is obtained.

By performing Step S4, n search results can be obtained for the respective search targets. For example, in the case of m documents to be searched, n search results can be obtained for each of the m documents. Note that in the case where m documents each include one or more blocks, n search results can be obtained for one or more blocks included in each document. In other words, n search results can be obtained from each block.

For example, in the case where a document group related to the first identifier is composed of a plurality of documents and one search query is received in Step S3, a search result is obtained on the basis of the search query, for one or each of a plurality of blocks included in each of the plurality of documents, in Step S4. For example, in the case where a document group related to the first identifier is composed of a plurality of documents and two search queries (the first search query and the second search query) are received in Step S3, a search result and a second search result are obtained on the basis of the first search query and the second search query, respectively, for one or each of a plurality of blocks included in each of the plurality of documents, in Step S4.

Note that Step S3 and Step S4 can be collectively referred to as a step of searching a document group with use of search queries. In other words, Step 3 and Step S4 can be collectively referred to as a step of searching at least one document to be searched with use of a search query including at least one keyword. Note that the method for searching a document group using the search query is not limited thereto.

### [Step S5]

In Step S5, the search result is output. For example, in Step S5, n search results are displayed on a display screen. Specifically, in Step S5, n search results for each block are displayed in a table format on the display screen. Note that in Step S5, n search results may be output as a file in a table format (e.g., a form of CSV). The output of n search results is not limited to the table format. For example, a tree format (tree structure) may be employed.

In the table, one of an item on the vertical axis and an item on the horizontal axis represents at least one of a document and a block, and the other represents a search query. In other words, one of the items on the vertical axis and the item on the horizontal axis represents an identifier for specifying a document, and the other represents a search result. Thus, it can be said that Step S5 is a step of outputting a search result from a block into a table format, together with an identifier for specifying the block. It can be also said that Step S5 is a step of outputting a search result from a block into a table format, together with an identifier for specifying a document including the block.

A region 310 illustrated in FIG. 4 is a region for displaying search results. Note that various kinds of data included in the database or the like may be displayed on the region 310. In FIG. 4, a table 320 showing search results is displayed in the region 310.

FIG. 4 is an example showing search results in a case where a document group to be searched is composed of a plurality of documents to which the first identifier is assigned (a plurality of documents whose first identifiers are the same). In the table 320 of FIG. 4, items on the vertical axis represents documents (item: item 353) and blocks (item: item 354), and items on the horizontal axis represents search queries (item: Keyword). Here, the item 353 corresponds to the third item, and the item 354 corresponds to the fourth item.

For example, when m documents are set to be searched and n search queries are received, the table 320 shows search results the number of which is obtained by multiplying the total number of blocks in the m documents by n.

FIG. 4 is also an example showing search results with an output of one search query (a search query 311) in a case where the search query is received and a block satisfies the search query. In FIG. 4, information that specifies a block is displayed on rows of each block. Specifically, the third identifier and the fourth identifier are displayed. In addition, the search query 311 is displayed on the first column with respect to rows of a block satisfying the search query 311, and the first column with respect to rows of a block not satisfying the search query 311 is blank.

For example, it is found from the table 320 in FIG. 4 that the block where the third identifier is 2 and the fourth identifier is 1 satisfies the search query 311. Furthermore, it is found that the block where the third identifier is 3 and the fourth identifier is 1 does not satisfy the search query 311. When the search query is displayed with information specifying a block (here, the information means the third identifier and the fourth identifier) in this manner, the results of document search can be efficiently checked.

Note that the arrangement order of a combination of a document and a block is not particularly limited. For example, the search results may be displayed in the registered order in a database. Alternatively, a document including more blocks satisfying a search query may be placed in the upper side of the table. Further alternatively, the user may choose a desired order from a plurality of kinds of sorts.

Furthermore, besides the table 320 showing the search results, at least one of a document and a block shown in the table 320 is preferably displayed in the region 310. In this case, the region 310 includes a region 330 that displays at least one of a document and a block shown in the table 320 as well as the table 320 showing the search results.

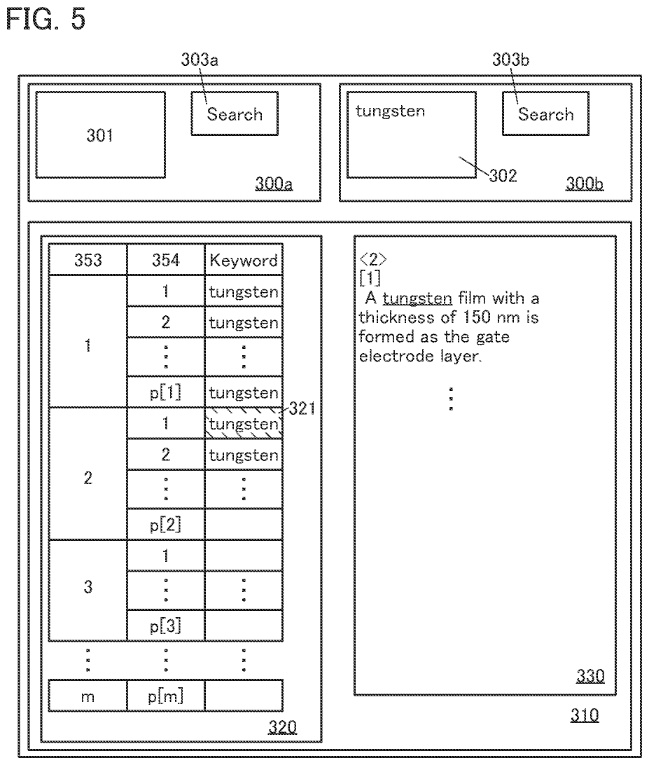

FIG. 5 is an example where the user inputs “tungsten” as a search query into the region 302 and selects the icon 303b denoted as “Search” with a mouse pointer, whereby the table 320 and at least one of a document and a block are displayed in the region 310. Here, the search query corresponds to be a keyword “tungsten”.

In the table 320 of FIG. 5, “tungsten” is displayed on the first row with respect to the column of the block satisfying the search query. In other words, in the table 320 of FIG. 5, the keyword (here, “tungsten”) found in the document is displayed together with information (here, the third identifier and the fourth identifier) specifying the document where the keyword is shown up. Accordingly, the document satisfying the search query can be specified promptly. In other words, the document where the keyword is shown up can be specified promptly.

Furthermore, in FIG. 5, a search result 321 is selected, and a block (one or more sentences included in the block) corresponding to the search result 321 is displayed in the region 330. Since the table 320 and the region 330 are included in the region 310, the table 320 and the sentences included in the selected document (here, the block) are displayed on the same screen.

After the table 320 is displayed on the screen, the identifier (the fourth identifier) assigned to the block or the search result of the block is selected from the table 320, whereby the block (one or more sentences included in the block) is displayed in the region 330. That is, it can be said that the method for outputting a document search result includes a step of displaying the search result on a screen and a step of displaying a sentence on the screen. Alternatively, it can be said that the method for outputting a document search result includes a first step of outputting a search result and a second step of outputting a sentence. In this case, the table 320 is displayed on the screen in the first step, and the sentence is displayed on the screen in the second step. Note that the sentence is a sentence included in a document selected from the table 320.

Specifically, a sentence satisfying the search query 311, which is assigned to a block where the third identifier is 2 and the fourth identifier is 1, is displayed in the region 330 illustrated in FIG. 5. For example, the region 330 can display a sentence satisfying the search query 311, a block including the sentence (a block where the third identifier is 1 and the fourth identifier is 2), or a document including the sentence (a document where the third identifier is 1). Furthermore, one or more sentences before or after the sentence or one or more blocks before or after the block may also be displayed.

The identifier assigned to any of the documents, the identifier assigned to any of the blocks, or the search result, illustrated in table 320, is selected, whereby the selected document, the selected block, or the document or block corresponding to the selected search result can be displayed in the region 330. Thus, the contents of a document or a block as well as the search result can be checked in a short time.

In the region 330, the keyword (“tungsten” in FIG. 5) is preferably highlighted. FIG. 5 shows an example in which the keyword is underlined, but the highlighting method is not limited thereto. For example, a keyword in a sentence can be highlighted by thickening the line of a character, using a color for the keywords different from a color for other characters, highlighting the keyword with a marker, or the like. Thus, the visibility of the keyword can be increased.

Furthermore, the identifier assigned to the selected document or the block may be displayed in the region 330. In FIG. 5, the third identifier (here, 2) is displayed with angle brackets, and the fourth identifier (here, 1) is displayed with square brackets. Without being limited thereto, the symbols used for displaying the identifier may be brackets other than the above, e.g., a frame, a figure, or the like. Accordingly, the contents of the document where the keyword is shown up and information identifying the document can be checked promptly.

When the identifier assigned to any of the documents, the identifier assigned to any of the blocks, or the search result, which does not satisfy the search query 311, is selected, the selected document, the selected block, or the document or block corresponding to the selected search result may be displayed in the region 330. In this case, the above keyword is not included in the document or block displayed in the region 330, which does not cause highlighted display.

The display of the document or block satisfying the search query 311 and the display of the document or block not satisfying the search query 311 are switched, whereby a change in the document or the block can be checked in a short time.

Each of the number of identifiers assigned to the selected document, the number of identifiers assigned to the block, or the number of search results is not limited to 1. Each of the number of identifiers assigned to the selected document, the number of identifiers assigned to the block, or the number of search results may two or more.

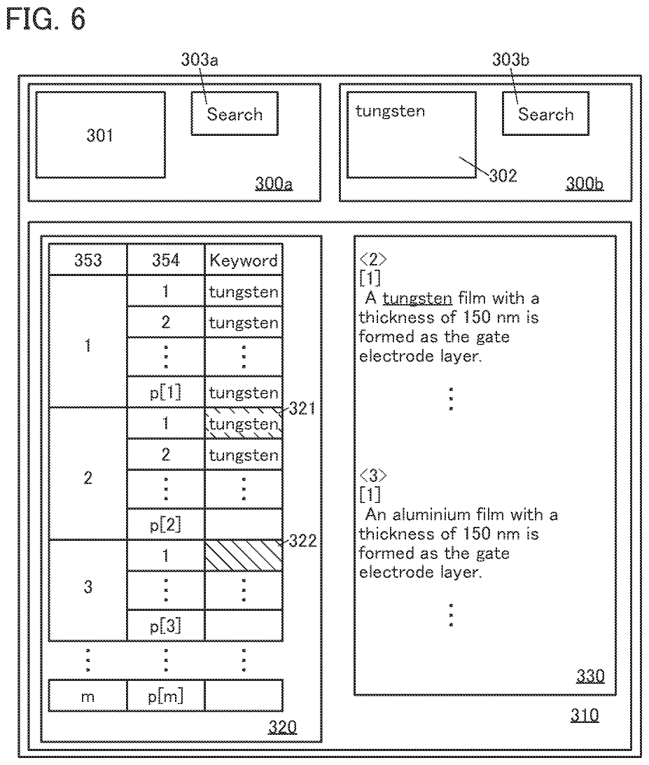

FIG. 6 shows an example in which the table 320 and two documents or blocks are displayed in the region 310. In FIG. 6, the search result 321 and a search result 322 are selected, a block corresponding to the search result 321 (one or more sentences included in the block) and a block corresponding to the search result 322 (one or more sentences included in the block) are displayed in the region 330.

Specifically, in FIG. 6, a sentence satisfying the search query 311 in the block where the third identifier is 2 and the fourth identifier 1 is displayed on the upper side in the region 330, and a sentence not satisfying the search query 311 in the block where the third identifier is 3 and the fourth identifier is 1 is displayed on the lower side in the region 330. Since a keyword is shown up in the sentence displayed on the upper side in the region 330, the keyword is highlighted in the sentence. On the other hand, since the keyword is not shown up in the sentence displayed on the lower side in the region 330, highlighting is not made in the sentence. With comparison between these two sentences, a change in documents can be checked in a short time.

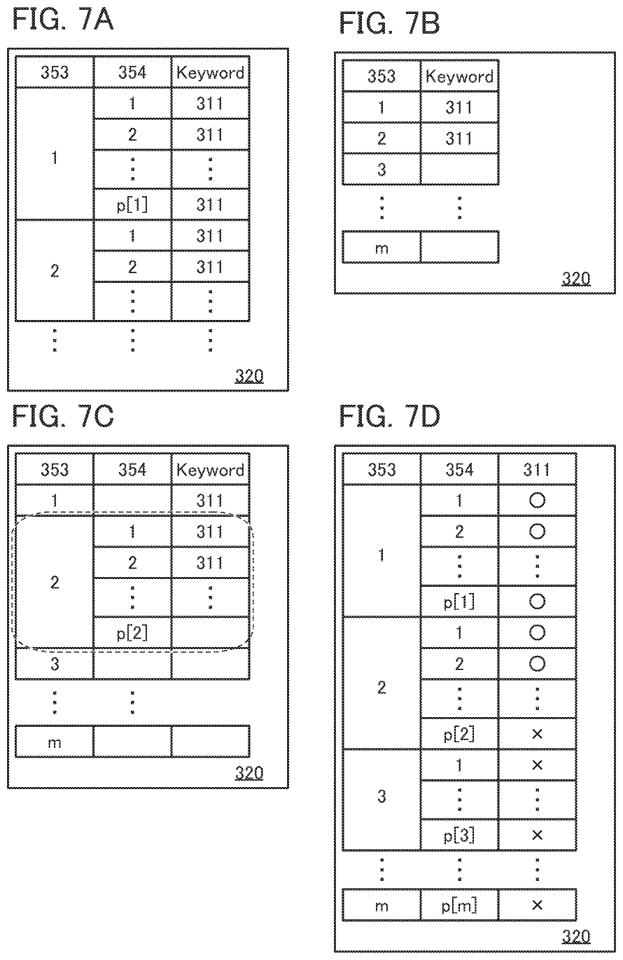

Each of the tables 320 illustrated in FIG. 7A to FIG. 9E is a variation of the table 320 illustrated in FIG. 4. In the description of FIG. 7A to FIG. 9E, description of portions similar to those in FIG. 4 is omitted in some cases.

In FIG. 4, rows of a block not satisfying the search query 311 is displayed, and the first column with respect to the rows is blank. Note that the display method of the block not satisfying the search query is not limited thereto. For example, rows of a block not satisfying the search query may be hidden.

FIG. 7A shows an example in which rows of a block not satisfying the search query 311 is not displayed in the table 320. For example, a block where the third identifier is 3 does not satisfy the search query 311 (see FIG. 4), rows of the block are not displayed. When only a block satisfying the search query 311 is displayed in this manner, a block satisfying the search query 311 can be checked in a short time.

In the table 320 in FIG. 4, the search result is displayed for each block. Note that the display method of search results is not limited thereto. FIG. 7B shows an example in which a search result is displayed for each document. In FIG. 7B, items on the vertical axis represent documents (item: item 353). In addition, the search query 311 is displayed on the first column with respect to rows of a document including at least one block satisfying the search query 311, and the first column with respect to rows of a document not including a block satisfying the search query 311 is blank.

From the table 320 in FIG. 7B, it is found that at least one of blocks in a document where the third identifier is 1 or 2 satisfies the search query 311. In addition, it is found that all blocks in a document where the third identifier is 3 does not satisfy the search query 311. When the search result is displayed for each document in this manner, information displayed on the table 320 is summarized, so that the overall view of the search results in the document group can be easily grasped.

In FIG. 7B, rows of a document not including a block satisfying the search query 311 are displayed and the first column with respect to the rows is blank; however, one embodiment of the present invention is not limited thereto. As in FIG. 7A, the rows of the document may be hidden.

In the table 320 in FIG. 7B, the confirmation of which block satisfies the search query is sometimes necessary in the document satisfying the search query. For such a case, the user selects the third identifier or a search result (e.g., a document where the third identifier is 2 or a search result of the document) with a mouse pointer on the table 320 in FIG. 7B, whereby a search result in the document corresponding to the selected third identifier or the selected search result may be displayed for each block as indicated with a dotted line in FIG. 7C. In this case, it can be said that search results of some of the documents are displayed for each block and search results of the other documents are displayed for each document in the table 320.

According to the table 320 in FIG. 7C, in a document where the third identifier is 2, a block where the fourth identifier is 1 or 2 satisfies the search query 311, and a block where the fourth identifier is p[2] does not satisfy the search query 311. In this manner, a block that satisfies the search query and a block that does not satisfy the search query in a document can be checked in a short time.

As described above, the display format of the table 320 can be changed when the user selects the identifier (e.g., the third identifier) assigned to documents, the identifier (e.g., the fourth identifier) assigned to blocks, or search results, with a mouse pointer. Accordingly, results of document search can be checked efficiently.

The search result shown in FIG. 4 is represented by outputting a search query when a block satisfies the search query; however, the output method of the search result is not limited thereto. For example, a search result may be shown on the basis of two-value notation such as whether or not a block satisfies a search query.

FIG. 7D shows an example of search results based on two-value notation, whether or not a block satisfies one search query, in the case where the one search query is received. In FIG. 7D, items on the horizontal axis represent search queries (e.g., the search query 311). Furthermore, circle marks are displayed on the first column with respect to rows of a block satisfying the search query 311, and cross marks are displayed on the first column with respect to rows of a block not satisfying the search query 311.

From the table 320 in FIG. 7D, it is found that the block where the third identifier is 2 and the fourth identifier is 1 satisfies the search query 311 (the circle mark in the figure). It is also found that the block where the third identifier is 3 and the fourth identifier is 1 does not satisfy the search query 311 (the cross mark in the figure). The search results are shown with two-value notation in this manner, which enables the results of document search to be checked intuitively.

As in FIG. 7A, in the table 320 in FIG. 7D, rows of a block not satisfying the search query 311 may be hidden. As in FIG. 7B, in the table 320 in FIG. 7D, the search result may be displayed for each document. As in FIG. 7C, search results of some of the documents are displayed for each block and search results of the other documents are displayed for each document.

When the search result is shown with two-value notation such as whether or not a document satisfies a search query, it is sometimes difficult to determine which block in the document satisfies the search query. Thus, the search results may be shown with multivalued notation and may be shown with three or more symbols. For example, in the case where a search result is displayed for each document as shown in FIG. 7B, a first symbol (e.g., circle mark) is used when all blocks included in a document satisfy a search query, a second symbol (e.g., cross mark) is used when none of blocks included in a document satisfies the search query, and a third symbol (e.g., triangle mark) is used when some of blocks included in a document satisfies the search query.

The display method of search result is not limited to the above. For example, the search results may be displayed by showing the number of blocks included in a document and the number of blocks satisfying the search query 311 in the table 320.

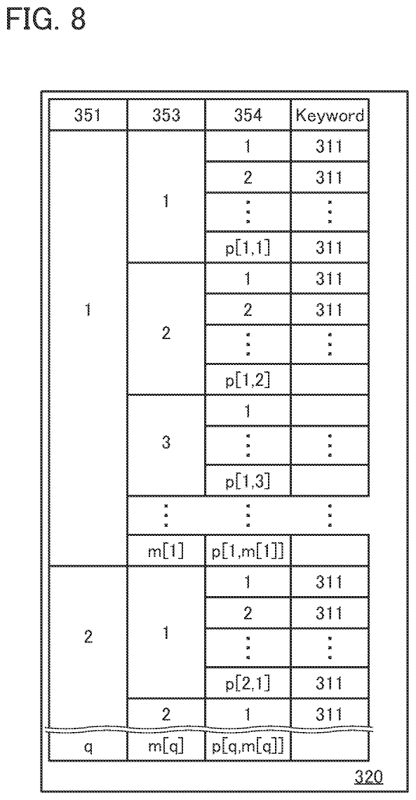

FIG. 8 is an example showing search results when a document group to be searched is composed of a document group to which the second identifier is assigned (a document group whose second identifiers are the same). In the table 320 in FIG. 8, items on the vertical axis represent documents (item: item 351 and item 353) and blocks (item: item 354), and items on the horizontal axis represent search queries (item: Keyword). Here, the item 351 corresponds to the first item.

Note that the example shown in FIG. 8 is the case where the document group to which the second identifier is assigned is composed of the first to q-th (q is an integer greater than or equal to 1) document groups, the j-th (j is an integer greater than or equal to 1 and less than or equal to q) is composed of m[j] (m[j] is an integer greater than or equal to 1) documents, and the k-th (k is an integer greater than or equal to 1 and less than or equal to m[j]) document, which is one of the m[j] documents, includes p[j,k] blocks. The first document group includes a plurality of documents whose first identifiers are the same, and the same applies to the second to q-th document groups. The number of documents included in the document group to be searched is the total number of documents included in the first to q-th document groups. When n search queries are received, the table 320 shows search results, the number of which is obtained by multiplying the total number of blocks in documents in the first o q-th document groups by n.

For example, when the first identifier is an application management number and the second identifier is an application family management number, q corresponds to the number of applications belonging to one patent family. In the j-th application that is one of applications, m[j] corresponds to the number of claims in “Scope of Claims” included in the j-th application. In other words, m[j] corresponds to the number of versions of “Scope of Claims” included in the j-th application.

FIG. 8 is an example showing search results by outputting one search query (the search query 311) when the search query is received and a block satisfies the search query. In FIG. 8, information for specifying blocks is displayed on rows of each block. Specifically, the first identifier, the third identifier, and the fourth identifier are displayed. The first column with respect to rows of a block satisfying the search query 311 displays the search query 311, and the first column with respect to rows of a block not satisfying the search query 311 is blank.

For example, from the table 320 in FIG. 8, it is found that a block where the first identifier is 1, the third identifier is 2, and the fourth identifier is 1 satisfies the search query 311. It is also found that a block where the first identifier is 1, the third identifier is 3, and the fourth identifier is 1 does not satisfy the search query 311. The document to be searched and blocks are shown in a table format in this manner, which enables efficient check of results of document search.

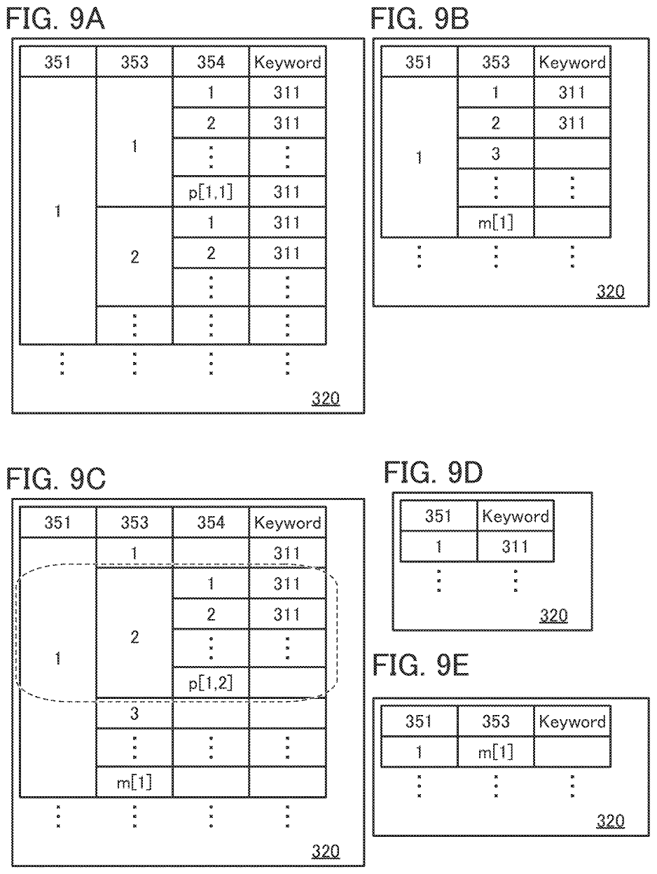

FIG. 9A to FIG. 9E each show a variation of the table 320 in FIG. 8. In the description of FIG. 9A to FIG. 9E, description of portions similar to those in FIG. 8 is omitted in some cases. Note that in FIG. 9A to FIG. 9E, display of rows of a document whose first identifier is other than 1 (greater than or equal to 2) is omitted.

As shown in FIG. 9A, in the table 320, rows of a block that does not satisfy the search query 311 may be hidden. Thus, only blocks satisfying the search query 311 are displayed, which enables the blocks satisfying the search query 311 to be checked in a short time.

As shown in FIG. 9B and FIG. 9D, the search result may be displayed for each document or each document group on the table 320. As in FIG. 7B, in FIG. 9B, the search query 311 is displayed on the first column with respect to rows of a document including at least one block satisfying the search query 311, and the first column with respect to rows of a document not including a block satisfying the search query 311 is blank.

For example, in FIG. 9B, a search result is displayed for each combination of the first identifier the third identifier. When the user selects the third identifier or the search result (e.g., a document where the first identifier is 1 and the third identifier is 2 or a search result of the document) with a mouse pointer on the table 320 in FIG. 9B, a search result in the document corresponding to the selected third identifier or the selected search result may be displayed for each block as indicated with a dotted line in FIG. 9C. Furthermore, for example, the display format may be changed into that of the table 320 in FIG. 9B when the user selects the third identifier or the fourth identifier (e.g., a document where the first identifier is 1 and the third identifier is 2) with a mouse pointer on the table 320 in FIG. 9C. Moreover, when the user selects the first identifier (e.g., a document group where the first identifier is 1) with a moue pointer on the table 320 in FIG. 9B, the display format may be changed into that of the table 320 in FIG. 8.

For example, in FIG. 9D, a search result is displayed for a document group where the first identifiers are the same. Note that when the user selects the first identifier or the search result (e.g., a document group where the first identifier is 1 or a search result of the document group) with a mouse pointer on the table 320 in FIG. 9D, the display format may be changed into that of the table 320 in FIG. 8 or FIG. 9B.

FIG. 9E shows a variation of the table 320 shown in FIG. 9D. The table 320 shown in FIG. 9E has in common with the table 320 shown in FIG. 9D that the search result is displayed for each first identifier. Note that in FIG. 9E, rows of a document where none of all blocks satisfy the search query 311 are displayed, and the first column with respect to the rows is blank.

The table 320 in FIG. 9E is different from the table 320 in FIG. 9D in that the search result in one of a plurality of documents whose first identifiers are 1 is displayed. For example, one document whose search results are displayed is a document whose third identifier is registered first or last, a document including a largest number of blocks satisfying the search query, or a document including the smallest number of blocks satisfying the search query, in a plurality of documents whose first identifiers are 1. When the user selects one of the first identifier and the third identifier with a mouse pointer, for example, the search result in a document to which the first identifier is assigned may be displayed for each third identifier. In other words, the search result may be displayed as shown in FIG. 9B.

As described above, when the search result is displayed for each document, information displayed on the table 320 is summarized, and accordingly the overall view of the search results in a document group can be easily grasped. When the user selects the first identifier, the third identifier, the fourth identifier, and the search result with a mouse pointer, the display format of the table 320 can be changed. Thus, the results of document search can be checked efficiently.

As in FIG. 7D, the search results may be shown with two-value notation such as whether or not a document or a block satisfies a search query on the tables 320 in FIG. 9B to FIG. 9E. Alternatively, the search results may be shown with symbols the number of which is based on the number of blocks satisfying the search query, or the number of blocks included in a document or the number of blocks satisfying the search query 311 may be shown on the table 320 as the search results.

The above is the description of examples showing search results in the case where one search query is received. Next, an example showing a search result in the case where two search queries are received will be described.

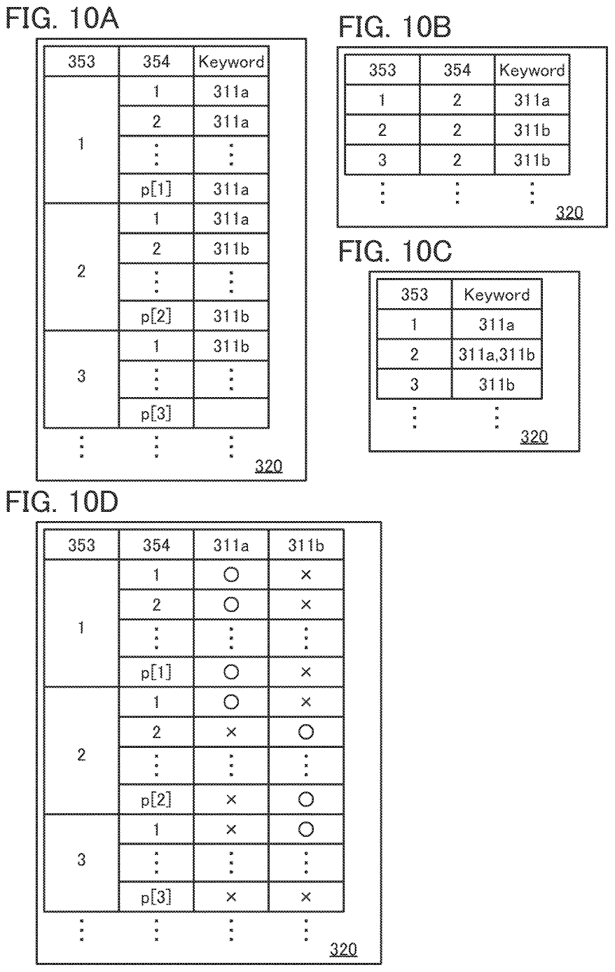

FIG. 10A is an example where search results are displayed by outputting two search queries when a document group to be searched is composed of a plurality of documents to which the first identifier is assigned and the two search queries are received. Here, the two search queries are a first search query 311a and a second search query 311b.

The table 320 in FIG. 10A has in common with the tables 320 in FIG. 4 to FIG. 7 that search results are shown in the case where a document group to be searched is composed of a plurality of documents to which the first identifier is assigned. Thus, the description of the portions similar to those in FIG. 4 to FIG. 7 can be referred to for the description of the table 320 shown in FIG. 10A.

In the table 320 in FIG. 10A, items on the vertical axis represents documents (item: item 353) and blocks (item: item 354), and items on the horizontal axis represents search queries (item: Keyword). In other words, in FIG. 10A, the search result based on the first search query 311a and the search result based on the second search query 311b are displayed on the first column. Specifically, the first search query 311a is displayed on the first column with respect to rows of a block satisfying the first search query 311a, and the second search query 311b is displayed on the first column with respect to rows of a block satisfying the second search query 311b. More specifically, the first search query 311a and the second search query 311b are displayed on the first column with respect to rows of a block satisfying the first search query 311a and the second search query 311b. In addition, the first search query 311a is also displayed on the first column with respect to rows of a block satisfying the first search query 311a and not satisfying the second search query 311b. The second search query 311b is displayed on the first column with respect to rows of a block not satisfying the first search query 311a and satisfying the second search query 311b. The first column with respect to rows of a block not satisfying the first search query 311a or the second search query 311b is blank.

From the table 320 in FIG. 10A, it is found that a block where the third identifier is 1 and the fourth identifier is 2 satisfies the first search query 311a and does not satisfy the second search query 311b. It is also found that a block where the third identifier is 2 and the fourth identifier is 2 does not satisfy the first search query 311a and satisfies the second search query 311b. Thus, when the third identifier is changed from 1 to 2 in the block where the fourth identifier is 2, it is possible to promptly determine that a keyword that is the first search query 311a is changed into a keyword that is the second search query 311b. As described above, a document or a block satisfying at least one search query is shown in a table format, which enables efficient check of a change in documents and results of document search.

Note that in FIG. 10A, the rows of a block that does not satisfy the first search query 311a or the second search query 311b is displayed, and the first column with respect to the rows is blank; instead, the rows of the block may be hidden.

FIG. 10B to FIG. 10D are each a variation of the table 320 shown in FIG. 10A. Each of the tables 320 in FIG. 10B to FIG. 10D has in common with the table 320 in FIG. 10A that search results are shown in the case where a document group to be searched is composed of a plurality of documents to which the first identifier is assigned and two search queries (the first search query and the second search query) are received. In the description of FIG. 10B to FIG. 10D, description of portions similar to those in FIG. 10A is omitted in some cases.

On the table 320 in FIG. 10B, a search result in one block included in a document is displayed. For example, on the table 320 in FIG. 10B, a search result in a block where the fourth identifier is 2 is displayed, and a search result in a block where the fourth identifier is other than 2 is not displayed. From the table 320 in FIG. 10B, it is found that a block where the third identifier is 1 and the fourth identifier is 2 satisfies the first search query 311a and does not satisfy the second search query 311b. It is also found that a block where the third identifier is 2 and the fourth identifier is 2 does not satisfy the first search query 311a and satisfies the second search query 311b. As described above, only search results in blocks whose fourth identifiers are the same are displayed, which enables a change in blocks to be checked in a short time.

On the table 320 in FIG. 10C, a search result is displayed for each document. In FIG. 10C, items on the vertical axis represent documents (item: item 353). In FIG. 10C, the first search query 311a is displayed on the first column with respect to rows of a document including at least one block satisfying the first search query 311a, and the second search query 311b is displayed on the first column with respect to rows of a document including at least one block satisfying the second search query 311b. Specifically, the first search query 311a and the second search query 311b are displayed on the first column with respect to rows of a document including at least one block satisfying the first search query 311a and at least one block satisfying the second search query 311b. In addition, the first search query 311a is displayed on the first column with respect to rows of a document including at least one block satisfying the first search query 311a and including no block satisfying the second search query 311b. Furthermore, the second search query 311b is displayed on the first column with respect to rows of a document including no block satisfying the first search query 311a and including at least one block satisfying the second search query 311b. Furthermore, the first column with respect to rows of a document including no block satisfying the first search query 311a and including block satisfying the second search query 311b is blank.

From the table 320 in FIG. 10C, it is found that a document where the third identifier is 1 includes one or more blocks satisfying the first search query 311a. It is also found that a document where the third identifier is 2 includes at least one block satisfying the first search query 311a and at least one block satisfying the second search query 311b. It is also found that a document where the third identifier is 3 includes one or more blocks satisfying the second search query 311b. As described above, when the search result is displayed for the document, information displayed on the table 320 is summarized, and accordingly the overall view of the search results in a document group can be easily grasped.

On the table 320 in FIG. 10D, search results are displayed with two-value notation such as whether or not a document or a block satisfies a search query. In the table 320 in FIG. 10D, items on the horizontal axis represents search queries (e.g., the first search query 311a and the second search query 311b). In other words, in FIG. 10D, the first column shows the search result based on the first search query 311a, and the second column shows the search result based on the second search query 311b.

From the table 320 in FIG. 10D, it is found that a block where the third identifier is 1 and the fourth identifier is 2 satisfies the first search query 311a (the circle mark in the figure) and does not satisfy the second search query 311b (the cross mark in the figure). It is also found that a block where the third identifier is 2 and the fourth identifier is 2 does not satisfy first search query 311a and satisfies the second search query 311b. The search results are shown with two-value notation in this manner, which enables the results of document search to be checked intuitively.

When the user selects an identifier (e.g., the third identifier) assigned to documents, an identifier (e.g., the fourth identifier) assigned to blocks, or search results with a mouse pointer, the display format of the table 320 can be changed. Thus, results of document search can be checked efficiently.

When the document or block is displayed in the region 330, a highlighting method is preferably different between a keyword input as the first search query 311a (referred to as a first keyword) and a keyword input as the second search query 311b (referred to as a second keyword). For example, when the first keyword in a sentence is highlighted using one of methods such as underlining the first keyword, thickening the line of a character, using a color for the keyword different from a color for other characters, and highlighting the keyword with a marker, the second keyword in the sentence may be highlighted using a method different from that used for highlighting the first keyword. Alternatively, for example, a method such as changing the color of a highlighting marker, a type of underlines, or a color of a character between the first keyword and the second keyword in the sentence may be method.

### [Display Example]

Here, an example of a display method of document search results will be described with reference to FIG. 11 and FIG. 12. FIG. 11 and FIG. 12 each illustrate an example of a graphical user interface (GUI) of the document search system of this embodiment.

Shown below is an example in which a database is an application database and a document group to be searched is composed of a plurality of “Scope of Claims”. Note that since the written amendment of proceedings includes amended “Scope of Claims”, a document group to be searched may include one or a plurality of written amendments of proceedings.

In the case where patent documents are documents to be searched, documents belonging to the same patent family are preferably grouped using INPADOC (registered trademark) or the like. Documents belonging to the same patent family have high similarity; thus, by showing the grouped results, the efficiency of checking search results and the contents of the documents can be greatly increased. The specification is common to applications belonging to the same patent family. Thus, if a change in patent application documents (specifically, “Scope of Claims”) can be checked in a short time, an examination process (e.g., a change in “Scope of Claims”) of one application in a single patent family can be referred to, so that another application can be considered efficiently.

Shown below is an example in which the first item is an application management number (including an in-house original number, a given number designated by a user, or the like), and the second item is an application family management number.

At this time, in the case where a document group to be searched is composed of a plurality of documents whose first identifiers are the same, the document group to be searched is a document group belonging to the same application. Alternatively, in the case where a document group to be searched is composed of a plurality of documents whose second identifiers are the same, the document group to be searched is a document group belonging to the same patent family. Hereinafter, an example is shown in which the document group to be searched is a document group belonging to the same patent family.

In the case where an application is pending, “Scope of Claims” before examination or during examination is amended in some cases. In addition, “Scope of Claims” is sometimes corrected after patent registration. In the case where “Scope of Claims” is amended or corrected, “Scope of Claims” before amendment or correction and “Scope of Claims” after amendment or correction are present as the application. In other words, by amendment or correction of “Scope of Claims”, a plurality of documents (“Scope of Claims”) whose application management numbers are the same are stored in the application database. Note that “amendment of Scope of Claims” in this specification includes “correction of Scope of Claims”.

Whether or not “Scope of Claims” is amended can be checked in documents treated as prosecution record or examination record of the application. In other words, a history management number (including an in-house original number, a given number designated by a user, or the like) is assigned to “Scope of Claims” in some cases. In this case, a document group to which the same application management number is assigned has different history management numbers from each other.

Shown below is an example where the third item is a history management number and the fourth item is a paragraph number. Note that the paragraph number as the fourth item can be rephrased as a claim number because the paragraph number in “Scope of Claims” is compatible with the claim number. Blocks included in a document correspond to claims.

In the above, when the number of the third items are two or more, at least one of documents to be searched includes a plurality of versions.

As illustrated in FIG. 11, the user selects the icon 303a denoted as “Search” with a mouse pointer after inputting “Patent A” as the first identifier into the region 301, whereby the document search system extracts a document group belonging to the same patent family as Patent A as a document group to be searched. In FIG. 11, at least Patent B belongs to the same patent family as Patent A.

Next, the user inputs “transistor” as a search query to the region 302, whereby the search query 311 becomes a keyword that is “transistor”. Then, the user selects the icon 303b denoted as “Search” with a mouse pointer, whereby the document search system obtains search results based on the search query 311, for one block or each of a plurality of blocks included in each of a plurality of documents included in the document group.

FIG. 11 shows the table 320 showing the above search results. The example shown in FIG. 11 is showing search results by outputting the search query. In FIG. 11, the search results for Patent A are shown for each block, and the search results for Patent B are shown for each document.

In the table 320 in FIG. 11, items on the vertical axis represent documents (item: Name (e.g., Patent A) and Log (e.g., 1)) and blocks (item: No., e.g., 1), and items on the horizontal axis represent keywords (item: Keyword). Here, “Name” corresponds to the first item (application management number), “Log” corresponds to the third item (history management number), and “No.” corresponds to the fourth item (claim number).

From the table 320 in FIG. 11, it is found that a block (here, a claim) in Patent A whose Log (the third identifier) is 2 and No. (the fourth identifier) is 1 includes “transistor”. It is also found that a block in Patent A whose Log is 3 and No. is 1 does not include “transistor”. Therefore, it can be promptly determined that the keyword “transistor” included in the block (claim) in Patent A whose fourth identifier (claim number) is 1 is replaced with another word or eliminated when the third identifier (management history number) is changed from 2 to 3. As described above, a document or a block satisfying the search query is shown in a table format, which enables efficient check of a change in documents or blocks and results of document search.

The example shown in FIG. 11 includes the region 330 displaying the contents of a document or a block in the region 310, in addition to the table 320 showing the search results. In FIG. 11, the search result 321 is selected. In the region 330, a block in Patent A whose Log is 2 and No. is 1 is displayed. Furthermore, in the region 330, the keyword “transistor” is underlined so that the keyword in the sentence is emphasized.

Next, FIG. 12 shows an example of a case where the user inputs two keywords, “transistor” and “switch”, as search queries in the region 302. In FIG. 12, line break is made as a delimiter of the keywords. In this case, the first search query 311a becomes a keyword that is “transistor”, and the second search query 311b becomes a keyword that is “switch”. The user selects the icon 303b denoted as “Search” with a mouse pointer, whereby the document search system obtains search results based on the first search query 311a and search results based on the second search query 311b, for one block or each of a plurality of blocks included in a plurality of documents included in the document group.

The example shown in FIG. 12 is showing search results by outputting the search queries. In FIG. 12, the search results for Patent A are shown for each block, and the search results for Patent B are shown for each document. The table 320 shown in FIG. 12 has in common with the table 320 shown in FIG. 11 that a document group to be searched belongs to the same patent family as Patent A. Thus, the description of the portion similar to those in FIG. 11 can be referred to for the description of the table 320 shown in FIG. 12.

In the table 320 in FIG. 12, items on the vertical axis represent documents (item: Name (e.g., Patent A) and Log (e.g., 1)) and blocks (item: No., e.g., 1), and items on the horizontal axis represent search queries (item: Keyword). Here, “Name” corresponds to the first item (application management number), “Log” corresponds to the third item (history management number), and “No.” corresponds to the fourth item (claim number).

From the table 320 in FIG. 12, it is found that a block (here, a claim) in Patent A whose Log (the third identifier) is 2 and No. (the fourth identifier) is 1 includes “transistor” and does not include “switch”. It is also found that a block in Patent A whose Log is 3 and No. is 1 includes “switch” and does not include “transistor”. Therefore, it can be promptly determined that the keyword “transistor” included in the block (claim) in Patent A whose fourth identifier (claim number) is 1 is replaced with the keyword “switch” when the third identifier (management history number) is changed from 2 to 3. As described above, a document or a block satisfying the search queries is shown in a table format, which enables efficient check of a change in documents or blocks and results of document search.

The example shown in FIG. 12 includes the region 330 displaying the contents of a document or a block in the region 310, in addition to the table 320 showing the search results. In FIG. 12, the search result 321 and the search result 322 are selected. In the region 330, a block in Patent A whose Log is 2 and No. is 1 and a block in Patent A whose Log is 3 and No. is 1 are displayed. Furthermore, in the region 330, the keyword “transistor” is underlined with a straight line and the keyword “switch” is underlined with a wavy line so that the keywords in the sentence are emphasized. In this manner, the method of emphasizing display is changed between a plurality of search queries when the plurality of search queries are received, whereby a change in keywords can be promptly determined. Thus, a change in documents can be checked efficiently.

As described above, the document search system of this embodiment enables a change in documents to be checked efficiently. In addition, searching on the basis of a plurality of search queries and checking search results can be performed efficiently. Thus, even in the case of many documents to be searched, needed information can be obtained in a short time. Moreover, even in the case of many documents to be searched, documents to be searched can be extracted without omission, and the content of extracted documents can be grasped efficiently.

This embodiment can be combined with the other embodiments as appropriate. In the case where a plurality of structure examples are described in one embodiment in this specification, the structure examples can be combined as appropriate.

### EMBODIMENT 2

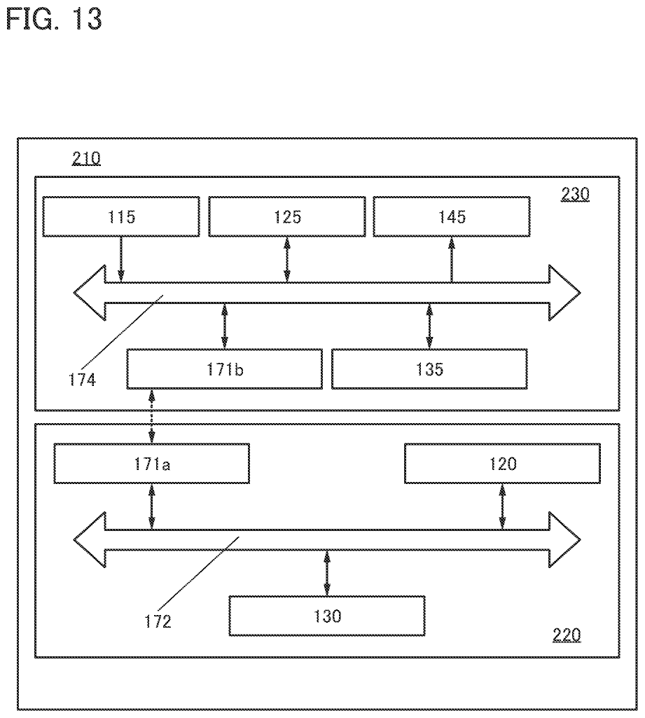

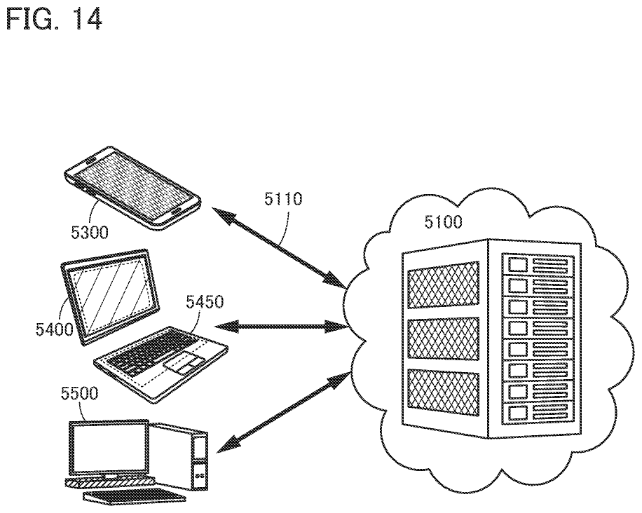

In this embodiment, a document search system of one embodiment of the present invention will be described with reference to FIG. 13 and FIG. 14.

### <Document Search System 2>

FIG. 13 shows a block diagram of a document search system 210. The document search system 210 includes a server 220 and a terminal 230 (e.g., a personal computer). Note that the description of <Document search system 1>in Embodiment 1 can be referred to for the same components as those in the document search system 100 shown in FIG. 1.

The server 220 includes a communication unit 171a, a transmission path 172, the storage unit 120, and the processing unit 130. Although not shown in FIG. 13, the server 220 may further include at least one of a reception unit, a database, an output unit, an input unit, and the like.

The terminal 230 includes a communication unit 171b, a transmission path 174, an input unit 115, a storage unit 125, a processing unit 135, and a display unit 145. Examples of the terminal 230 include a tablet terminal, a laptop information terminal, and a variety of portable information terminals. The terminal 230 may be a desktop information terminal without the display unit 145 and may be connected to a monitor functioning as the display unit 145, or the like.

The user of the document search system 210 inputs an identifier of a document group to be searched and a search query from the input unit 115 of the terminal 230 to the server 220. These input contents are transmitted from the communication unit 171b to the communication unit 171a. For example, the identifier of a document group to be searched and the search query are transmitted from the communication unit 171a to the communication unit 171b.

The information received by the communication unit 171a is stored in a memory included in the processing unit 130 or the storage unit 120 via the transmission path 172. The information may be supplied from the communication unit 171a to the processing unit 130 via a reception unit (see the reception unit 110 illustrated in FIG. 1).

Various kinds of processing described in <Method for displaying document search result> in Embodiment 1 are performed in the processing unit 130. These kinds of processing require high processing capacity, and thus are preferably performed in the processing unit 130 included in the server 220. The processing unit 130 preferably has higher processing capacity than the processing unit 135.

A processing result of the processing unit 130 is stored in the memory included in the processing unit 130 or the storage unit 120 via the transmission path 172. After that, the processing result is output from the server 220 to the display unit 145 of the terminal 230. The processing result is transmitted from the communication unit 171a to the communication unit 171b. On the basis of the processing result of the processing unit 130, various kinds of data contained in a database may be transmitted from the communication unit 171a to the communication unit 171b. The processing result may be supplied from the processing unit 130 to the communication unit 171a via an output unit (the output unit 140 illustrated in FIG. 1).

[Communication Unit 171a and Communication Unit 171b]

The server 220 and the terminal 230 can transmit and receive data with use of the communication unit 171a and the communication unit 171b. As the communication unit 171a and the communication unit 171b, a hub, a router, a modem, or the like can be used. Data may be transmitted and received through wire communication or wireless communication (e.g., radio waves or infrared rays).

### [Transmission Path 172 and Transmission Path 174]

The transmission path 172 and the transmission path 174 have a function of transmitting data. The communication unit 171a, the storage unit 120, and the processing unit 130 can transmit and receive data via the transmission path 172. The communication unit 171b, the input unit 115, the storage unit 125, the processing unit 135, and the output unit 140 can transmit and receive data via the transmission path 174.

### [Input Unit 115]

The input unit 115 can be used when the user designates a document group and a search query. For example, the input unit 115 can have a function of operating the terminal 230; specific examples thereof include a mouse, a keyboard, a touch panel, a microphone, a scanner, and a camera.

The document search system 210 may have a function of converting audio data into text data. For example, at least one of the processing unit 130 or the processing unit 135 may have this function.

The document search system 210 may have an optical character recognition (OCR) function. This enables characters contained in image data to be recognized and text data to be created. For example, at least one of the processing unit 130 or the processing unit 135 may have this function.

### [Storage Unit 125]

The storage unit 125 may store one or both of the data on the designated document and the data supplied from the server 220. The storage unit 125 may include at least part of the data that can be included in the storage unit 120.

### [Processing Unit 130 and Processing Unit 135]

The processing unit 135 has a function of performing arithmetic operation or the like with use of data supplied from the communication unit 171b, the storage unit 125, the input unit 115, or the like. The processing unit 135 may have a function of executing at least part of processing that can be performed by the processing unit 130.

Each of the processing unit 130 and the processing unit 135 can include one or both of a transistor including a metal oxide in its channel formation region and a transistor including silicon in its channel formation region (Si transistor).

In this specification and the like, a transistor including an oxide semiconductor or a metal oxide in a channel formation region is referred to as an oxide semiconductor transistor or an OS transistor. A channel formation region of an OS transistor preferably includes a metal oxide.

In this specification and the like, a metal oxide is an oxide of metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases. That is, when a metal oxide can form a channel formation region of a transistor that has at least one of an amplifying function, a rectifying function, and a switching function, the metal oxide can be referred to as a metal oxide semiconductor or shortly as an OS.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than that of indium. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The semiconductor layer may be a metal oxide that does not contain indium and contains zinc, a metal oxide that does not contain indium and contains gallium, a metal oxide that does not contain indium and contains tin, or the like, e.g., zinc tin oxide or gallium tin oxide.

The processing unit 130 preferably includes an OS transistor. The OS transistor has an extremely low off-state current; thus, with use of the OS transistor as a switch for retaining electric charge (data) that has flowed into a capacitor functioning as a storage element, a long data retention period can be ensured. When at least one of a register and a cache memory included in the processing unit 130 has such a feature, the processing unit 130 can be operated only when needed, and otherwise can be off while data processed immediately before turning off the processing unit 130 is stored in the storage element. In other words, normally-off computing is possible and the power consumption of the document search system can be reduced. The same applies to the processing unit 135.

### [Display Unit 145]

The display unit 145 has a function of displaying an output result. Examples of the display unit 145 include display devices such as a liquid crystal display device and a light-emitting display device. Examples of light-emitting elements that can be used in the light-emitting display device include an LED (Light Emitting Diode), an OLED (Organic LED), a QLED (Quantum-dot LED), and a semiconductor laser. It is also possible to use, as the display unit 145, a display device using a MEMS (Micro Electro Mechanical Systems) shutter element, an optical interference type MEMS element, or a display device using a display element employing a microcapsule method, an electrophoretic method, an electrowetting method, an Electronic Liquid Powder (registered trademark) method, or the like, for example.

FIG. 14 is a conceptual diagram of the document search system of this embodiment.

The document search system illustrated in FIG. 14 includes a server 5100 and terminals (also referred to as electronic devices). Communication between the server 5100 and each terminal is conducted via an Internet connection 5110.

The server 5100 is capable of performing arithmetic operation using data input from the terminal via the Internet connection 5110. The server 5100 is capable of transmitting an arithmetic operation result to the terminal via the Internet connection 5110. Accordingly, the burden of arithmetic operation on the terminal can be reduced.

In FIG. 14, an information terminal 5300, an information terminal 5400, and an information terminal 5500 are shown as the terminals. The information terminal 5300 is an example of a portable information terminal such as a smartphone. The information terminal 5400 is an example of a tablet terminal. When the information terminal 5400 is connected to a housing 5450 with a keyboard, the information terminal 5400 can be used as a laptop information terminal. The information terminal 5500 is an example of a desktop information terminal.

With such a structure, the user can access the server 5100 from the information terminal 5300, the information terminal 5400, the information terminal 5500, and the like. Then, through the communication via the Internet connection 5110, the user can receive a service offered by an administrator of the server 5100. Examples of the service include a service with use of the document search method of one embodiment of the present invention. In the service, artificial intelligence may be utilized in the server 5100.

This embodiment can be combined with the other embodiments as appropriate.

### REFERENCE NUMERALS

100: document search system, 110: reception unit, 115: input unit, 120: storage unit, 125: storage unit, 130: processing unit, 135: processing unit, 140: output unit, 145: display unit, 150: transmission path, 171a: communication unit, 171b: communication unit, 172: transmission path, 174: transmission path, 210: document search system, 220: server, 230: terminal, 300a: region, 300b: region, 300: region, 301: region, 302: region, 303a: icon, 303b: icon, 303: icon, 304: mouse pointer, 310: region, 311a: first search query, 311b: second search query, 311: search query, 320: table, 321: search result, 322: search result, 330: region, 351: item, 353: item, 354: item, 5100: server, 5110: Internet connection, 5300: information terminal, 5400: information terminal, 5450: housing, 5500: information terminal

1. A method for outputting a document search result comprising:
specifying at least one document that is to be searched;
searching the at least one document using a search query comprising at least one keyword;
displaying a search result on a screen; and
displaying a sentence on the screen,
wherein the at least one document comprises a plurality of versions,
wherein in displaying a search result on a screen, a keyword shown up in each of the versions of the document is displayed together with information specifying the versions comprising the keyword shown up, and
wherein the sentence is included in any one of the versions of the document selected from the search result displayed on the screen.

2. The method for outputting a document search result according to claim 1, wherein in displaying a sentence on the screen, the keyword included in the sentence is emphasized.

3. The method for outputting a document search result according to claim 1,
wherein the document is Scope of Claims belonging to a patent application, and
wherein each of the plurality of versions corresponds to an amendment in Scope of Claims in an examination process.

4. A method for outputting a document search result comprising:
receiving an identifier;
receiving a search query;
obtaining a search result based on the search query from one or each of a plurality of blocks included in each of a plurality of documents related to the identifier; and
outputting the search result from the block as a first table, together with the identifier specifying the block.

5. The method for outputting a document search result according to claim 4, wherein the search query is output when each of the plurality of documents comprises at least one block satisfying the first query, so that the search result is output into the first table.

6. The method for outputting a document search result according to claim 4, further comprising:
outputting a sentence,
wherein in outputting the search result as a first table, the first table is displayed on a screen,
wherein the sentence is included in a document selected from the first table, and
wherein in outputting a sentence, the sentence is displayed on the screen.

7. The method for outputting a document search result according to claim 6, wherein in the sentence displayed on the screen, a keyword included in the search query is emphasized.

8. A method for outputting a document search result comprising:
receiving an identifier;
receiving a first search query and a second search query;
obtaining a first search result based on the first search query and a second search result based on the second search query from one or each of a plurality of blocks included in each of a plurality of documents related to the identifier; and
outputting the first search result and the second search result from the block as a first table, together with the identifier specifying a sentence comprising the block.

9. The method for outputting a document search result according to claim 8,
wherein the first search query is output when each of the plurality of documents comprises at least one block satisfying the first search query, so that the first search result is output into the first table, and
wherein the second search query is output when each of the plurality of documents comprises at least one block satisfying the second search query, so that the second search result is output into the first table.

10. The method for outputting a document search result according to claim 8, further comprising:
outputting a sentence,
wherein in outputting the first search result and the second search result as a first table, the first table is displayed on a screen, and
wherein the sentence is included in a document selected from the first table displayed on the screen, and
wherein in outputting a sentence, the sentence is displayed on the screen.

11. The method for outputting a document search result according to claim 10, wherein in the sentence displayed on the screen, a keyword included in the first search query and a keyword included in the second search query are emphasized.

12. The method for outputting a document search result according to claim 4,
wherein each of the plurality of documents is Scope of Claims,
wherein the identifier is an application management number or an application family management number, and
wherein the block is a claim.

13. A document search system, comprising:
a storage unit;
a reception unit;
a processing unit; and
an output portion,
wherein the storage unit comprises a database,
wherein the reception unit is configured to receive a search query and an identifier,
wherein the processing unit is configured to extract a plurality of documents related to the identifier from the data base and configured to obtain a search result based on the search query from one or each of a plurality of blocks included in each of the plurality of documents extracted from the database, and
wherein the output unit is configured to output the search result obtained from the block as a first table, together with the identifier specifying any of the documents comprising the block.

14. The document search system according to claim 13, wherein the search query is output when each of the plurality of documents comprises at least one block satisfying the search query, so that the search result is output into the first table.

15. A document search system, comprising:
a storage unit;
a reception unit;
a processing unit; and
an output portion,
wherein the storage unit comprises a database,
wherein the reception unit is configured to receive a first search query, a second search query, and an identifier,
wherein the processing unit is configured to extract a plurality of documents related to the identifier from the database and configured to obtain a first search result based on the first search query and a second search result based on the second search query from one or each of a plurality of blocks included in each of the plurality of documents extracted from the database, and
wherein the output unit is configured to output the first search result and the second search result obtained from the block as a first table, together with the identifier specifying any of the documents comprising the block.

16. The document search system according to claim 15,
wherein the first search query is output when each of the plurality of documents comprises at least one block satisfying the first search query, so that the first search result is output into the first table, and
wherein the second search query is output when each of the plurality of documents comprises at least one block satisfying the second search query, so that the second search result is output into the first table.

17. The document search system according to claim 13,
wherein the database is an application database,
wherein each of the plurality of documents is Scope of Claims,
wherein the identifier is an application management number or an application family management number, and
wherein the block is a claim.
